(19) United States
(12) Patent Application Publication
(10) Pub. No.: US 2025/0179324 A1
(43) Pub. Date: Jun. 5, 2025

(54) LIQUID COMPSITION, INSULATING RESIN LAYER, ELECTRODE FOR ELECTROCHEMICAL ELEMENT, ELECTRODE LAMINATE, ELECTROCHEMICAL ELEMENT, AND METHOD OF MANUFACTURING ELECTRODE LAMINATE

(71) Applicants: Ryuji Higashi, Kanagawa (JP); Kayato Ohya, Kanagawa (JP)

(72) Inventors: Ryuji Higashi, Kanagawa (JP); Kayato Ohya, Kanagawa (JP)

(73) Assignee: Ricoh Company, Ltd., Tokyo (JP)

(21) Appl. No.: 18/960,345

(22) Filed: Nov. 26, 2024

(30) Foreign Application Priority Data
Nov. 30, 2023 (JP) 2023-202560

(51) Int. Cl. C09D 133/10; H01M 10/0562; H01M 50/486

(52) U.S. Cl. CPC C09D 133/10; H01M 50/486; H01M 10/0562; H01M 2300/0068

(57) ABSTRACT

A liquid composition contains a polymerizable compound represented by Chemical Formula 1 or Chemical Formula 2, a non-linkable resin having a structural unit represented by Chemical Formula 3, and a solvent,
wherein the solvent is a solvent mixture comprising a good solvent that dissolves the polymerizable compound and a poor solvent that leaves the polymerizable undissolved, and the solvent satisfies the following Relationship 1,

Polymerizable compound soluble point≤Mixing ratio X<Polymerizable compound soluble point+11 Relationship 1
where the mixing ratio X represents a content ratio by percentage based on a mass of the good solvent in the solvent mixture, and the polymerizable compound soluble point represents a minimum content ratio by percentage based on the mass of the good solvent in the solvent mixture.

### CROSS-REFERENCE TO RELATED APPLICATIONS

This patent application is based on and claims priority pursuant to 35 U.S.C. § 119 to Japanese Patent Application No. 2023-202560, filed on Nov. 30, 2023, in the Japan Patent Office, the entire disclosure of which is hereby incorporated by reference herein.

### BACKGROUND

### Technical Field

The present disclosure relates to a liquid composition, an insulating resin layer, an electrode for an electrochemical element, an electrode laminate, an electrochemical element, and a method of manufacturing the electrode laminate.

### Description of the Related Art

Solid state secondary batteries are superior in terms of safety compared with typical lithium-ion secondary batteries because they are resistant to temperature changes and have a lower risk of ignition. Additionally, they can be rapidly charged, which enhances performance. For these reasons, the demand for their use in electric vehicles and other applications is expected to expand. Furthermore, there is a growing need for thin batteries to be installed in various wearable devices and medical patches, leading to diversified requirements for solid state secondary batteries.

### SUMMARY

According to embodiments of the present disclosure, a liquid composition is provided which a polymerizable compound represented by the following Chemical Formula 1 or Chemical Formula 2;
a non-linkable resin having a structural unit represented by the following Chemical Formula 3; and
a solvent,

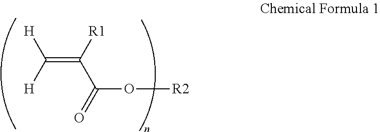

where R1 represents a hydrogen atom or a methyl group, R2 represents a hydrocarbon chain, an alkylene oxide chain, a polyester chain, or an acrylic oligomer ester derivative, and n represents an integer from 2 to 6,

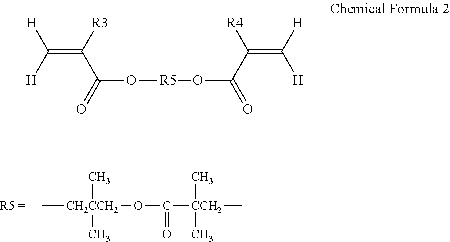

where R3 and R4 each, independently, represent hydrogen atoms or methyl groups,

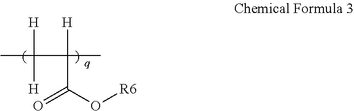

where, R6 represents an alkyl group,
wherein the solvent is a solvent mixture comprising a good solvent that dissolves the polymerizable compound and a poor solvent that leaves the polymerizable undissolved, and
the solvent satisfies the following Relationship 1,

Polymerizable compound soluble point≤Mixing ratio X<Polymerizable compound soluble point+11 Relationship 1
where the mixing ratio X represents a content ratio by percentage based on a mass of the good solvent in the solvent mixture, and the polymerizable compound soluble point represents a minimum content ratio by percentage based on the mass of the good solvent in the solvent mixture.

As another aspect of embodiments of the present disclosure, a liquid composition contains a polymerizable compound represented by the following Chemical Formula 1 or Chemical Formula 2, a non-linkable resin having a structural unit represented by the following Chemical Formula 3, and a solvent.

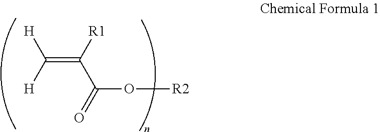

where R1 represents a hydrogen atom or a methyl group, R2 represents a hydrocarbon chain, an alkylene oxide chain, a polyester chain, or an acrylic oligomer ester derivative, and n represents an integer from 2 to 6,

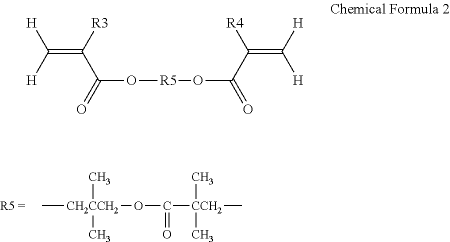

where R3 and R4 each, independently, represent hydrogen atoms or methyl groups,

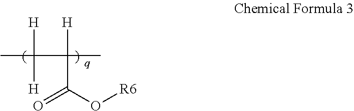

where, R6 represents an alkyl group,
wherein the solvent is a solvent mixture comprising a good solvent that dissolves the polymerizable compound and a poor solvent that leaves the polymerizable undissolved, and the solvent satisfies the following Relationship 2.

Solvent soluble point≤Mixing ratio Y≤Solvent soluble point+21 Relationship 2

In Relationship 2, the mixing ratio Y represents the content ratio by percentage based on a mass of the insoluble polymerizable compound in the compound mixture, and the solvent soluble point represents the minimum content ratio by percentage based on the mass of the insoluble polymerizable compound in the compound mixture.

As another aspect of embodiments of the present disclosure, an insulating resin layer is provided which contains a cured product of the liquid composition mentioned above, the insulating resin layer having a porous structure.

As another aspect of embodiments of the present disclosure, electrode for an electrochemical element is provided which includes a substrate, an electrode composite layer disposed on the substrate, and an insulating resin layer disposed at a peripheral portion of the electrode composite layer, wherein the insulating resin layer is a cured product of the liquid composition of claim 1 and has a porous structure.

As another aspect of embodiments of the present disclosure, an electrode laminate is provided which includes a substrate, an electrode composite layer disposed on the substrate, an insulating resin layer disposed at a peripheral portion of the electrode composite layer, and a solid electrolyte layer disposed on the electrode composite layer and the insulating resin layer, the solid electrolyte layer comprising a solid electrolyte, wherein the insulating resin layer is a cured product of the liquid composition mentioned above and has a porous structure.

As another aspect of embodiments of the present disclosure, an electrochemical element is provided which includes the electrode laminate mentioned above.

As another aspect of embodiments of the present disclosure, a method of manufacturing an electrode laminate is provided which includes forming an electrode composite layer on a substrate, forming an insulating resin layer at a peripheral portion of the electrode composite layer, including applying the liquid composition mentioned above to the substrate and applying heat or light to the liquid composition to cure the liquid composition; and forming a solid electrolyte layer on the insulating resin layer and the electrode composite layer.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a cross-sectional view of a device for manufacturing an electrode for electrochemical element according to the present disclosure;

FIG. 2A is a schematic diagram illustrating a cross sectional view of an electrode laminate according to the present disclosure;

FIG. 2B is a schematic diagram illustrating a cross sectional view of an electrode laminate according to the present disclosure;

FIG. 2C is a schematic diagram illustrating a cross sectional view of an electrode laminate according to the present disclosure;

FIG. 3 is a schematic diagram illustrating a top view of a device for manufacturing an electrode for electrochemical element according to an embodiment of the present disclosure;

FIG. 4 is a schematic diagram illustrating a top view of a device for manufacturing an electrode for electrochemical element according to the present disclosure;

FIG. 5 is a schematic diagram illustrating a top view of a device for manufacturing an electrode for electrochemical element according to the present disclosure;

FIG. 6A is a schematic diagram illustrating a cross sectional view (part 1) of a positional relationship between the insulating resin layer and electrode composite layer in an electrode for electrochemical element according to the present disclosure;

FIG. 6B is a schematic diagram illustrating a cross sectional view (part 2) of a positional relationship between the insulating resin layer and electrode composite layer in an electrode for electrochemical element according to the present disclosure;

FIG. 6C is a schematic diagram illustrating a cross sectional view (part 3) of a positional relationship between the insulating resin layer and electrode composite layer in an electrode for electrochemical element according to the present disclosure;

FIG. 6D is a schematic diagram illustrating a cross sectional view (part 4) of a positional relationship between the insulating resin layer and electrode composite layer in an electrode for electrochemical element according to the present disclosure;

FIG. 7 is a schematic diagram illustrating a top view of a positional relationship between the insulating resin layer and electrode composite layer in an electrode for electrochemical element according to the present disclosure;

FIG. 8A is a schematic diagram illustrating a cross sectional view (part 1) of a relationship of the average thickness between the insulating resin layer and electrode composite layer in an electrode for electrochemical element according to the present disclosure;

FIG. 8B is a schematic diagram illustrating a cross sectional view (part 2) of a relationship of the average thickness between the insulating resin layer and electrode composite layer in an electrode for electrochemical element according to the present disclosure;

FIG. 8C is a schematic diagram illustrating a cross sectional view (part 3) of a relationship of the average thickness between the insulating resin layer and electrode composite layer in an electrode for electrochemical element according to the present disclosure;

FIG. 9 is a schematic diagram illustrating an example of a device (liquid discharging device) for manufacturing an insulating resin layer to execute the method of manufacturing the electrode laminate according to the present disclosure;

FIG. 10 is a schematic diagram illustrating an example of a device (liquid discharging device) for manufacturing an insulating resin layer to execute the method of manufacturing the electrode laminate according to the present disclosure;

FIG. 11 is a schematic diagram illustrating a method of manufacturing an electrode for electrochemical element according to the present disclosure;

FIG. 12 is a schematic diagram illustrating an example of a device (liquid discharging device) for manufacturing an insulating resin layer to execute the method of manufacturing the electrode laminate according to the present disclosure;

FIG. 13 is a diagram illustrating a configuration of an example of the printing unit employing an inkjet method and transfer method as the liquid composition applying device in a device for manufacturing insulating resin layers according to the present disclosure;

FIG. 14 is a diagram illustrating a configuration of an example of the printing unit employing an inkjet method and transfer method as the liquid composition applying device in a device for manufacturing insulating resin layers according to the present disclosure;

FIG. 15 is a schematic diagram illustrating an electrochemical element according to the present disclosure;

FIG. 16 is a schematic diagram illustrating a solid state battery, which is an electrochemical element according to the present disclosure; and

FIG. 17 is a schematic diagram illustrating a mobile object, which is an electrochemical element according to the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a liquid composition is provided which forms a resin layer excellent for achieving curl development effects during film forming.

Typically, a laminate including a positive electrode, a solid electrolyte layer, and a negative electrode is sometimes pressed under extremely high pressure during production to improve the performance of solid state batteries, such as achieving a highly dense battery. This extremely high pressure pressing raises a concern of damage such as cracking in the solid electrolyte layer.

As for solid state secondary batteries, for example, in an attempt to provide a solid-state battery that can minimize cracks occurring during lamination pressing in the manufacturing process and prevent short circuits caused by tab contact, a positive electrode for a solid state battery has been proposed in WO 2020-022111 A1. This positive electrode includes a positive current collector and a positive active material layer, which contains a positive active material formed on the positive current collector, with a guide for the active material layer positioned on two sides of the outer perimeter of the positive active material layer.

This guide is designed to prevent short circuits, so it must have insulating properties and a thickness similar to that of the electrode composite layer. Additionally, because the active material layer guide needs to withstand high-pressure pressing, it is preferred to be made of a resin-based material that has a certain degree of viscoelasticity.

If the active material layer guide is formed by coating and curing a liquid composition in which resin is dissolved, the resulting film needs to be thicker than the desired guide. Since this coating raises concerns about dripping at the edges, a photocurable liquid composition is commonly used as a liquid composition to produce the active material layer guide.

Photocurable liquid compositions often contain a photopolymerization initiator and an acrylic polyfunctional polymerizable compound. In the case of photocuring with such a photocurable liquid composition containing a polyfunctional polymerizable compound, a large number of polymerizable compounds polymerize into a single molecule, leading to volume shrinkage due to the gap between the van der Waals distance and the covalent bond distance. Also, if curing is performed in the presence of a diluting solvent, the polymerization occurs in a significantly swollen state due to the impregnation of the diluting solvent, resulting in volume shrinkage during the solvent removal process. These volume shrinkages raise concerns about the delamination of the active material layer guide from the substrate, the occurrence of curling (warping) of the substrate, and, as a result, the damage to the adjacent electrode composite layer.

The addition of fillers or liquid additives, commonly referred to as solvents, to liquid compositions is widely practiced to minimize such volume shrinkage (refer to. For example, Journal of network polymer, Japan, Vol. 36, No. 6 (2015). In particular, if a liquid additive has a boiling point of at highest 300 degrees Celsius is used, the liquid additive can be removed by heating and drying under atmospheric pressure. However, at present, the differences in the effects of minimizing volume shrinkage depending on the type of solvent used have not been clearly presented.

In the case of material systems specifically for solid state secondary batteries, the liquid composition often contains a monomer and a non-polar solvent, which exhibits relatively low intermolecular interactions. Liquid compositions with such a composition tend to have reduced viscosity. A liquid film made using a low-viscosity liquid composition is prone to flow on the substrate, making it difficult to form a thick liquid film. For example, in the active material layer guide described in WO 2020-022111 A1 mentioned above, a film thickness equivalent to that of the active material layer (for example, 100 μm or more) is required to prevent short-circuiting. However, it may be difficult to meet this requirement with low-viscosity liquid compositions.

It is known that adding a resin to a liquid composition increases viscosity (refer to, for example, Japanese journal of polymer science and technology VOL. 69, No. 11, 613-622 (2012). However, with many resins, there is a concern that the resin layer may deform during volume shrinkage, making it difficult to obtain a resin layer with the desired shape. Furthermore, this deformation of the resin layer attributable to volume shrinkage raises another concern that the resin layer may peel off from the substrate.

The liquid composition of the present disclosure is capable of fully addressing various concerns in the prior art. More specifically, it is possible to develop a liquid composition that can form a resin layer with excellent curl development reduction during film formation.

The present disclosure is described in detail below.

### Liquid Composition

As a first embodiment of the liquid composition of the present disclosure, the liquid composition contains a polymerizable compound represented by Chemical Formula 1 or Chemical Formula 2, a non-crosslinked resin having a structural unit represented by Chemical Formula 3, and a solvent. The solvent is a solvent mixture containing a good solvent the dissolves the polymerizable compound and a poor solvent that leaves the polymerizable compound undissolved, and the solvent satisfies yjr following Relationship 1.

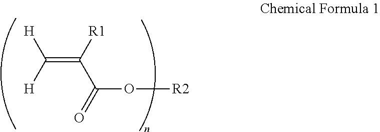

In Chemical Formula 1, R1 represents a hydrogen atom or a methyl group, R2 represents a hydrocarbon chain, an alkylene oxide chain, a polyester chain, or an acrylic oligomer ester derivative, and n represents an integer from 2 to 6.

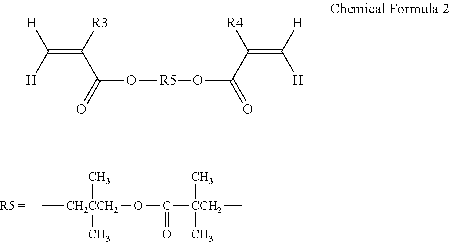

In Chemical Formula 2, R3 and R4 each, independently, represent hydrogen atoms or methyl groups.

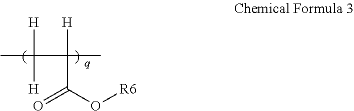

In Chemical Formula 3, R6 represents an alkyl group.

Polymerizable compound soluble point≤Mixing ratio X<Polymerizable compound soluble point+11 Relationship 1

In Relationship 1, the mixing ratio X represents a content ratio by percentage based on a mass of the good solvent in the solvent mixture, and the polymerizable compound soluble point represents a minimum content ratio by percentage based on the mass of the good solvent in the solvent mixture.

As a second embodiment of the liquid composition of the present disclosure, the liquid composition contains a polymerizable compound represented by Chemical Formula 1 or Chemical Formula 2, a non-crosslinked resin having a structural unit represented by Chemical Formula 3, and a solvent. The polymerizable compound is a compound mixture containing a soluble polymerizable compound soluble to the solvent and an insoluble polymerizable compound insoluble to the solvent, and the polymerizable compound satisfies the following Relationship 2.

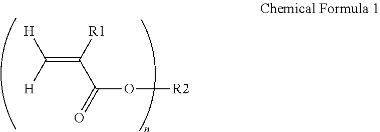

In Chemical Formula 1, R1 represents a hydrogen atom or a methyl group, R2 represents a hydrocarbon chain, an alkylene oxide chain, a polyester chain, or an acrylic oligomer ester derivative, and n represents an integer from 2 to 6.

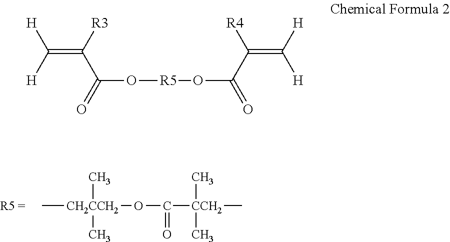

In Chemical Formula 2, R3 and R4 each, independently, represent hydrogen atoms or methyl groups.

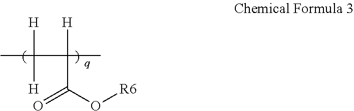

In Chemical Formula 3, R6 represents an alkyl group.

Solvent soluble point≤Mixing ratio Y<Solvent soluble point+21 Relationship 2

In Chemical Formula 2, the mixing ratio Y represents a content ratio by percentage based on a mass of the insoluble polymerizable compound in the compound mixture, and the solvent soluble point represents a minimum content ratio by percentage based on the mass of the insoluble polymerizable compound in the compound mixture.

In the present specification, the “liquid composition of the first embodiment” and the “liquid composition of the second embodiment” may simply be referred to as “liquid composition.”

In the present specification, the “polymerizable compound represented by Chemical Formula 1 or Chemical Formula 2” may simply be referred to as “polymerizable compound.”

In the present specification, the “non-crosslinked resin having a structural unit represented by Chemical Formula 3” may simply be referred to as “non-crosslinked resin.”

### Polymerizable Compound

The polymerizable compound in the present disclosure is represented by Chemical Formula 1 or Chemical Formula 2 and contains multiple units of mono-substituted ethylene, 1,1-disubstituted ethylene, 1,2-disubstituted ethylene, and/or diene compounds, which can be radically polymerized.

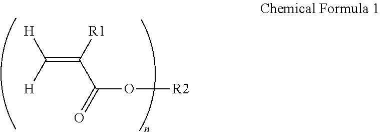

In Chemical Formula 1, R1 represents a hydrogen atom or a methyl group, R2 represents a hydrocarbon chain, an alkylene oxide chain, a polyester chain, or an acrylic oligomer ester derivative, and n represents an integer from 2 to 6.

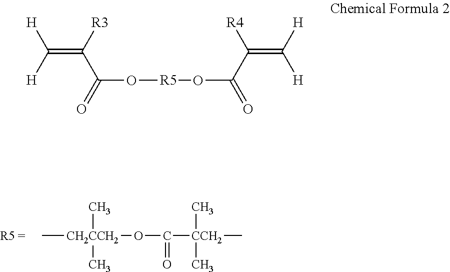

In Chemical Formula 2, R3 and R4 each, independently, represent hydrogen atoms or methyl groups.

n in Chemical Formula 1 is preferably 2 or 3, and more preferably 2 to reduce curling that occurs during the curing of the liquid composition.

To achieve a superior curl development reduction effect, it is preferable that the liquid composition of the present disclosure include a polymerizable compound in which R2 in Chemical Formula 1 is a polyester chain, or a polymerizable compound represented by Chemical Formula 2. It is more preferable that the composition include a polymerizable compound in which R2 in Chemical Formula 1 is a polycaprolactone chain.

As for the polymerizable compound, from the perspective of polymerization rate, it preferably has an acrylic group, that is, R1 in Chemical Formula 1 and R3 and R4 in Chemical Formula 2 are preferably hydrogen atoms.

In general, acrylic groups have high radical polymerizability, allowing for the rapid formation of cured products in liquid compositions by using a photopolymerization initiator or a thermal polymerization initiator in combination. Cured products can be obtained without the use of polymerization initiators. However, in the case of a polymerizable compound with an acrylic group (i.e., R1 in Chemical Formula 1 and R3 and R4 in Chemical Formula 2 are hydrogen atoms), it is preferable from the perspective of polymerization rate and equipment cost to use the polymerizable compound in combination with a thermal polymerization initiator or a photopolymerization initiator in the liquid composition, and it is even more preferable to use the polymerizable compound in combination with a photopolymerization initiator.

Specific examples of the polymerizable compounds include, but are not limited to, difunctional alkyl acrylates, hydroxy pivalic acid neopentyl glycol acrylate adducts, difunctional polyethylene glycol acrylates, difunctional polypropylene glycol acrylates, difunctional polytetramethylene glycol acrylates, difunctional cyclic acrylates, difunctional alkoxylated aromatic acrylates, difunctional acrylic acid polymer ester acrylates, difunctional caprolactam-modified acrylates, trifunctional trimethylolpropane acrylates, trifunctional alkoxylated glycerin acrylates, trifunctional isocyanate acrylates, tetrafunctional pentaerythritol acrylates, tetrafunctional ditrimethylolpropane acrylates, tetrafunctional diglycerin tetraacrylates, hexafunctional dipentaerythritol hexaacrylates, and polyester acrylates.

Among these, from the perspective of volumetric shrinkage, difunctional alkyl acrylate, difunctional polyethylene glycol acrylate, difunctional alkoxylated aromatic acrylate, difunctional acrylate oligomer ester acrylate, trifunctional trimethylolpropane acrylate, trifunctional alkoxylated glycerin acrylate, and trifunctional isocyanate acrylate are preferred, with difunctional alkyl acrylate, difunctional polyethylene glycol acrylate, difunctional alkoxylated aromatic acrylate, and difunctional acrylate oligomer ester acrylate being more preferred.

Moreover, among difunctional alkyl acrylates, difunctional polyethylene glycol acrylates, difunctional alkoxylated aromatic acrylates, and difunctional acrylic acid polymer ester acrylates, difunctional polyethylene glycol acrylates, difunctional acrylic acid polymer ester acrylates, and difunctional polyester acrylates are more preferable.

Specific examples of the difunctional alkyl acrylates include, but are not limited to, those sold under the trade names NK Ester A-HD-N, A-NON-N, A-DOD-N, and A-NPG (all available from Shin-Nakamura Chemical Co., Ltd.), Light Acrylate NP-A, MPD-A, 1,6HX-A, and 1,9ND-A (all available from Kyoeisha Chemical Co., Ltd.), and KAYARAD NPGDA (available from Nippon Kayaku Co., Ltd.).

Specific examples of the hydroxy pivalic acid neopentyl glycol acrylate adducts include, but are not limited to, those sold under the trade names Light Acrylate HPP-A (available from Kyoeisha Chemical Co., Ltd.), Biscoat #195, Biscoat #230, and Biscoat #260 (all available from OSAKA ORAGANIC CHEMICAL INDUSTRY LTD.), Miramer M210 and Miramer M216 (both available from Miwon Speciality Chemical Co., Ltd.), and KAYARAD FM-400 (available from Nippon Kayaku Co., Ltd.).

Specific examples of the difunctional polyethylene glycol acrylates include, but are not limited to, those sold under the trade names NK Ester A-200, NK Ester A-400, NK Ester A-600, and NK Ester A-1000 (all available from Shin Nakamura Chemical Co., Ltd.), Light Acrylate 3EG-A, Light Acrylate 4EG-A, Light Acrylate 9EG-A, and Light Acrylate 14EG-A (all available from Kyoeisha Chemical Co., Ltd.), Brenmar ADE-200, Brenmar ADE-300, and Brenmar ADE-400A (all available from NOF Corporation), and Miramer M202 (available from Miwon Speciality Chemical Co., Ltd.).

Specific examples of the difunctional polypropylene glycol acrylates include, but are not limited to, those sold under the trade names NK Ester APG-200, NK Ester APG-400, and NK Ester APG-700 (all available from Shin Nakamura Chemical Co., Ltd.), Biscoat #310HP (available from OSAKA ORAGANIC CHEMICAL INDUSTRY LTD.), Brenmar ADP-400 (available from NOF Corporation), and Miramer M210, Miramer M216, and Miramer M220 (all available from Miwon Speciality Chemical Co., Ltd.).

Specific examples of the difunctional polytetramethylene glycol acrylates include, but are not limited to, those sold under the trade names NK Ester A-PTMG65 (available from Shin Nakamura Chemical Co., Ltd.), Light Acrylate PTMGA-250 (available from Kyoeisha Chemical Co., Ltd.), and Brenmar ADT-250 (available from NOF Corporation).

Specific examples of the difunctional cyclic acrylates include, but are not limited to, those sold under the trade names NK Ester A-DCP (available from Shin Nakamura Chemical Co., Ltd.), Light Acrylate DCP-A (available from Kyoeisha Chemical Co., Ltd.), and KAYARAD R-604 and KAYARAD R-684 (both available from Nippon Kayaku Co., Ltd.).

Specific examples of the difunctional alkoxylated aromatic acrylates include, but are not limited to, those sold under the trade names NK Ester ABE-300, A-BPE-4, A-BPE-10, and A-BPE-20 (all available from Shin Nakamura Chemical Co., Ltd.), Light Acrylate BP-4EAL, BA-134, and BP-10EA (all available from Kyoeisha Chemical Co., Ltd.), Biscoat #540 (available from Osaka Organic Chemical Industry Ltd.), and KAYARAD R-551 and KAYARAD R-712 (both available from Nippon Kayaku Co., Ltd.).

A specific example of the difunctional acrylic acid polymer ester acrylate is Biscoat #230D (available from Osaka Organic Chemical Industry Ltd.).

Specific examples of the difunctional caprolactam-modified acrylates include, but are not limited to, those sold under the trade names KAYARAD HX-220 and KAYARAD HX-620 (both available from Nippon Kayaku Co., Ltd.).

Specific examples of the trifunctional trimethylolpropane acrylates include, but are not limited to, those sold under the trade names NK Ester A-TMPT, A-TMPT-9EO, and AT-20E (all available from Shin Nakamura Chemical Co., Ltd.), Light Acrylate TMP-3EO-A and Light Acrylate TMP-6EO-3A (both available from Kyoeisha Chemical Co., Ltd.), and Biscoat #295 (available from Osaka Organic Chemical Industry Ltd.).

Specific examples of the trifunctional alkoxylated glycerin acrylates include, but are not limited to, those sold under the trade names NK Ester A-GLY-3E, A-GLY-9E, and A-GLY-20E (all available from Shin Nakamura Chemical Co., Ltd.).

Specific examples of the trifunctional isocyanate acrylates include, but are not limited to, those sold under the trade names NK Ester A-9300 and A-9200YN (both available from Shin Nakamura Chemical Co., Ltd.).

Specific examples of the tetrafunctional pentaerythritol acrylates include, but are not limited to, those sold under the trade names NK Ester A-TMMT and ATM-35E (both available from Shin Nakamura Chemical Co., Ltd.) and Light Acrylate PE-3A and Light Acrylate PE-4A (both available from Kyoeisha Chemical Co., Ltd.).

A specific example of the tetrafunctional ditrimethylolpropane acrylate is NK Ester AD-TMP (available from Shin Nakamura Chemical Co., Ltd.).

A specific example of the tetrafunctional diglycerin tetraacrylate is Light Acrylate DGE-4E (available from Kyoeisha Chemical Co., Ltd.).

A specific example of the hexafunctional dipentaerythritol hexaacrylate is Light Specific examples of the polyester acrylates include, but are not limited to, those sold under the trade names Aronix M-6100, Aronix M-6200, Aronix M-6250, Aronix M-6500, Aronix M-7100, Aronix M-8030, Aronix M-8060, Aronix M-8100, Aronix M-8530, Aronix M-8560, and Aronix M-9050 (all available from Toagosei Co., Ltd.), Ebecryl 81, Ebecryl 88, Ebecryl 80, Ebecryl 657, Ebecryl 1657, Ebecryl 800, Ebecryl 805, Ebecryl 808, Ebecryl 810, Ebecryl 1810, Ebecryl 450, Ebecryl 1830, Ebecryl 1870, Ebecryl 2870, Ebecryl 830, Ebecryl 835, Ebecryl 870, Ebecryl 84, and IRR 302 (all available from Daicel-Ornex Co., Ltd.), RCC13-429 (available from Sannopco Co., Ltd.), Diabeam UK-4003 and Diabeam UK-4203 (both available from Mitsubishi Chemical Corporation), CN2203, CN2270, CN2271, CN2273, and CN2274 (all available from Arkema Co., Ltd.), and KAYARAD HX-220 and KAYARAD HX-620 (both available from Nippon Kayaku Co., Ltd.).

As for the polymerizable compounds, it is sufficient if at least one polymerizable compound represented by Chemical Formula 1 or Chemical Formula 2 is included. In other words, the polymerizable compounds contained in the liquid composition may contain only a polymerizable compound represented by Chemical Formula 1 or Chemical Formula 2, or may contain two or more different polymerizable compounds represented by Chemical Formula 1 or Chemical Formula 2. In either case, in addition to the polymerizable compounds represented by Chemical Formula 1 or Chemical Formula 2, polymerizable compounds that do not meet Chemical Formula 1 or Chemical Formula 2 may also be contained.

Preferably, the liquid composition in the present disclosure contains no polymerizable compounds that do not meet Chemical Formula 1 or Chemical Formula 2 to minimize the deterioration of the sulfide solid electrolyte. Furthermore, the liquid composition in the present disclosure preferably contains two or more different polymerizable compounds represented by Chemical Formula 1 or Chemical Formula 2 to expand the controllable range of the physical properties (for example, elastic modulus) of the insulating resin layer.

There are no particular limitations on the photopolymerization initiator, and it can be selected as appropriate according to the purpose. Examples include, but are not limited to, alkylphenone-based polymerization initiators, acylphosphine sulfite-based polymerization initiators, and oxime ester-based polymerization initiators.

Specific examples of alkylphenone-based polymerization initiators include, but are not limited to, products such as Omnirad 651, Omnirad 184, Omnirad 1173, Omnirad 2959, Omnirad 127, Omnirad 907, Omnirad 369, Omnirad 369E, and Omnirad 379EG (all available from IGM Resins B.V).

Specific examples of acylphosphine sulfite-based polymerization initiators include, but are not limited to, products such as Omnirad TPO and Omnirad 819 (both available from IGM Resins B.V.).

Specific examples of oxime ester-based polymerization initiators include, but are not limited to, products such as Irgacure OXE01, Irgacure OXE02, Irgacure OXE03, and Irgacure OXE04 (all available from BASF Japan).

The proportion of the polymerization initiator is not particularly limited and can be suitably selected to suit to a particular application. The content is preferably 0.05 to 10.0 percent by mass, and more preferably 0.1 to 5.0 percent by mass, of the total polymerizable compound to achieve a sufficient curing rate.

### Non-Crosslinked Resin

The non-crosslinked resin in the present disclosure has structural units represented by Chemical Formula 3. In other words, the non-crosslinked resin in the present disclosure is a non-crosslinked polymer compound containing an acrylic monomer having an acrylate ester group as a structural unit.

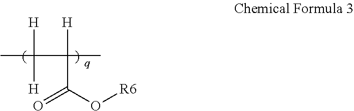

In Chemical Formula 3, R6 represents an alkyl group.

The term ‘non-crosslinked polymer compound’ refers to a polymer compound that lacks a three-dimensional network structure due to cross-linking. It excludes branched polymers, graft polymers, and dendrimers, which do not possess a network structure.

There are no particular restrictions on the value of q in the structural unit represented by Chemical Formula 3; it can be selected based on the purpose. Preferably, the value should be between 100 and 100,000, and more preferably between 1,000 and 100,000, to control the viscosity of the liquid composition.

There are no particular restrictions on R6 in the structural unit represented by Chemical Formula 3 as long as it is an alkyl group, and it can be appropriately selected according to the purpose. R6 is preferably methyl, ethyl, iso-propyl, n-propyl, tert-butyl, iso-butyl, or n-butyl to increase the glass transition point. If R6 in the structural unit represented by Chemical Formula 3 has these structures, the glass transition point will not drop below room temperature, resulting in the formation of a solid resin layer. The solid resin layer obtained can maintain its shape even during processes such as compression in the manufacturing of electrochemical devices because it has sufficient strength, and it can also prevent peeling from the substrate.

It is sufficient if the non-crosslinked resin includes at least one type of the structural unit represented by Chemical Formula 3. The non-crosslinked resin contained in the liquid composition may include only the structural unit represented by Chemical Formula 3, or it may include two or more different structural units represented by Chemical Formula 3. In either case, the non-crosslinked resin may also contain other structural units that do not satisfy Chemical Formula 3 in addition to the structural units represented by Chemical Formula 3.

In the present disclosure, the non-crosslinked resin is preferably a copolymer consisting of two or more structural units, to increase the glass transition temperature. In other words, the non-crosslinked resin in the present disclosure is preferably a copolymer containing the structural unit represented by Chemical Formula 3 and other structural units. If the non-crosslinked resin contains two or more structural units, the glass transition point does not become lower than room temperature, allowing for the formation of a solid resin layer. The solid resin layer obtained can maintain its shape even during processes such as compression in the manufacturing of electrochemical devices because it has sufficient strength, and it can also prevent peeling from the substrate.

There are no particular restrictions on the other structural units, and they can be appropriately selected depending on the purpose. To achieve superior prevention effect on curl development due to volume shrinkage, it is preferable that the structural unit be represented by Chemical Formula 4.

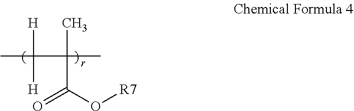

In Chemical Formula 4, R7 represents methyl, ethyl, iso-propyl, n-propyl, tert-butyl, iso-butyl, or n-butyl.

There are no particular restrictions on the value of r in the structural unit represented by Chemical Formula 4; it can be selected based on the purpose. Preferably, the value should be between 100 and 100,000, and more preferably between 1,000 and 100,000, to control the viscosity of the liquid composition.

In the present disclosure, the copolymer related to the non-crosslinked resin is preferably a block copolymer to minimize curl caused by volume shrinkage.

There are no particular restrictions on the method of obtaining the block copolymer, and it can be appropriately selected according to the purpose.

Specific examples include, but are not limited to, anionic polymerization (including coordination anionic polymerization), cationic polymerization, radical polymerization (including atom transfer radical polymerization and reversible addition-fragmentation chain transfer polymerization), ring-opening metathesis polymerization, and methods for stepwise preparation of block polymers using polycondensation or addition reactions to terminal diols or diamine polymers.

The copolymer related to the non-crosslinked resin in the present disclosure can be either synthesized or procured commercially. Specific examples of the products include, but are not limited to, Clarity LA4285, Clarity LA2270, Clarity LA2250, Clarity LA2140, Clarity LA2330, Clarity LA3320, Clarity LA3710, and Clarity LK9243 (all available from Kuraray Co., Ltd.).

The weight average molecular weight Mw of the non-crosslinked resin in the present disclosure is not particularly restricted and can be appropriately selected according to the intended purpose. It is preferably 5,000 or more in terms of stickiness.

### Solvent

The term “solvent” in the present disclosure refers to an organic solvent with a water content at most 1 percent by mass, and is preferably a low-polarity, hydrophobic solvent that exhibits low reactivity with the solid electrolyte layer.

The solvent is expected to act as a buffer for curing shrinkage, as there is no fluctuation in intermolecular distances between solvent-solvent or resin-solvent during polymerization.

Specific examples of the solvent include, but are not limited to, aromatic hydrocarbons such as toluene, xylene, mesitylene, anisole, and phenetole; hydrocarbon solvents such as hexane, heptane, nonane, octane, decane, menthane, cyclohexane, cyclooctane, and p-menthane; ester solvents such as ethyl butyrate, ethyl valerate, ethyl caproate, ethyl heptanoate, ethyl octanoate, ethyl nonanoate, ethyl decanoate, ethyl undecanoate, ethyl laurate, methyl butyrate, methyl valerate, methyl caproate, methyl heptanoate, methyl octanoate, methyl nonanoate, methyl decanoate, methyl undecanoate, methyl laurate, ethyl isovalerate, isoamyl acetate, isobutyl isobutyrate, 3-methoxyisobutyric acid methyl ester, butyl isobutyrate, isobutyl isovalerate, 2-methylbutyl isobutyrate, butyl isovalerate, heptyl acetate, isoamyl isovalerate, 2-ethylhexyl acetate, hexyl butyrate, ethyl benzoate, hexyl caproate, n-amyl octanoate, and hexyl acetate; and petroleum-based solvent mixtures.

Specific examples of the petroleum-based solvent mixtures include, but are not limited to, products sold under the trade names ISOPAR E, ISOPAR G, ISOPAR H, ISOPAR H BHT, ISOPAR L, ISOPAR M, EXXSOL D40, EXXSOL D80, EXXSOL D110, EXXSOL D130, EXXSOL DSP 80/100, and EXXSOL DSP 145/60 (all available from ANDOH PARACHEMIE CO., LTD.).

The content of the solvent is not particularly restricted and can be appropriately selected according to the purpose. From the viewpoint of curl development reduction, the solvent is at least 30 percent by mass of the total amount of the liquid composition, more preferably at least 40 percent by mass, and even more preferably at least 50 percent by mass. Additionally, the solvent content is preferably 70 or more percent by mass to control the film thickness.

The solvent in the present disclosure may be a combination of multiple solvents to increase the diversity of polymerizable compound selection.

### Second Aspect of Liquid Composition

As one aspect of the first liquid composition in the present disclosure, the solvent in the liquid composition is a solvent mixture containing both good and poor solvents to minimize curling due to volume shrinkage, and satisfies the following Formula 1.

Polymerizable compound soluble point≤Mixing ratio X<Polymerizable compound soluble point+11 Relationship 1

In the present specification, “good solvent” refers to a solvent in which the polymerizable compound is soluble. In the present specification, “poor solvent” refers to a solvent which leaves the polymerizable compound undissolved. Furthermore, in the present specification, “solvent mixture” refers to a solvent that contains both good and poor solvents.

In this specification, “mixing ratio X” refers to the percentage-based content ratio of the good solvent in a solvent mixture by mass in the solvent mixture.

In this specification, “polymerizable compound soluble point” refers to the minimum content ratio by mass of the good solvent in a solvent mixture in which the polymerizable compound is soluble, expressed as a percentage.

The term “soluble” in the first aspect is explained below. “Soluble” refers to the property where, after mixing the solvent and the polymerizable compound followed by ultrasonic stirring for 15 minutes with an ultrasonic stirrer (USS-1), no turbidity or phase separation occurs after standing for 10 minutes at a specified temperature. The specified temperature is not particularly limited as long as it is the ambient temperature during actual use. For example, it includes 25 degrees Celsius.

The determination of solubility or insolubility is made according to the composition of the liquid composition. For example, the following patterns 1 to 3 can be considered.

### Pattern 1

In the case of a liquid composition containing one polymerizable compound represented by Chemical Formula 1 or Chemical Formula 2 and two solvents (solvent mixture), the solubility or insolubility is determined based on the solvent ratio in a liquid composition that contains 10 g of the solvent mixture and 1 g of the polymerizable compound represented by Chemical Formula 1 or Chemical Formula 2.

### Pattern 2

In the case of a liquid composition containing two polymerizable compounds (compound mixture) represented by Chemical Formula 1 or Chemical Formula 2 and two solvents (solvent mixture), the solubility or insolubility is determined based on the solvent ratio in a liquid composition that contains 10 g of the solvent mixture and 1 g of the compound mixture of compounds.

### Pattern 3

For a liquid composition containing two types of polymerizable compounds (compound mixture) represented by Chemical Formula 1, or Chemical Formula 2, one type of polymerizable compound not satisfying Chemical Formula 1, and two types of solvents (solvent mixtures), the solubility is determined using a mixture of 10 g of solvent mixtures and 1 g of a mixture of the compound mixture and the polymerizable compound not satisfying Chemical Formula 1 or Chemical Formula 2 contained in the liquid composition based on the monomer ratio.

Relationship 1 can also be transformed into Relationship 1′.

0≤Mixing ratio X−Polymerizable compound soluble point≤11 Relationship 1′

The liquid composition of this aspect can form a resin layer with high porosity based on the phase separation rate under Formula 1 or Formula 1′. As a result, it is possible to suppress volume shrinkage during the curing of the liquid composition, thereby forming a high-quality resin layer.

Furthermore, as the “mixing ratio X-polymerizable compound solubility point” in Formula 1′ approaches zero, the curling due to volume shrinkage can be further reduced.

### Second Aspect of Liquid Composition

As a second aspect of the liquid composition in the present disclosure, the polymerizable compound in the liquid composition is a compound mixture containing both a soluble polymerizable compound and an insoluble polymerizable compound to reduce curling development due to volume shrinkage, and satisfies the following Relationship 2.

Solvent soluble point≤Mixing ratio Y<Solvent soluble point+21 Relationship 2

In the present specification, the term “soluble polymerizable compound” refers to a polymerizable compound that is soluble in a solvent. The term “insoluble polymerizable compound” refers to a polymerizable compound that is insoluble in a solvent. Additionally, when the term “compound mixture” is used in the present specification, it refers to a polymerizable compound that contains both soluble and insoluble polymerizable compounds.

The term “mixing ratio Y” refers to the percentage of the mass-based content of the insoluble polymerizable compounds within the compound mixture.

The term “solvent soluble point” refers to the minimum content ratio (percentage) based on the mass of the insoluble polymerizable compounds in the compound mixture that is soluble to the solvent.

The term “soluble” in the second aspect is explained below. “Soluble” refers to the property where, after mixing the solvent and the polymerizable compound followed by ultrasonic stirring for 15 minutes with an ultrasonic stirrer (USS-1), no turbidity or phase separation occurs after standing for 10 minutes at a specified temperature. The specified temperature is not particularly limited as long as it is the ambient temperature during actual use. For example, it includes 25 degrees Celsius.

The determination of solubility or insolubility is made according to the composition of the liquid composition. For example, the following patterns 4 to 6 can be considered.

### Pattern 4

In the case of a liquid composition containing one polymerizable compound represented by Chemical Formula 1 or Chemical Formula 2 and two solvents (solvent mixture), the solubility or insolubility is determined based on the monomer ratio in a liquid composition that contains 10 g of the polymerizable compound represented by Chemical Formula 1 or Chemical Formula 2 and 1 g of the solvent mixture.

### Pattern 5

In the case of a liquid composition containing two polymerizable compounds (compound mixture) represented by Chemical Formula 1 or Chemical Formula 2 and two solvents (solvent mixture), the solubility or insolubility is determined based on the solvent ratio in a liquid composition that contains 10 g of the compound mixture and 1 g of the solvent mixture.

### Pattern 6

For a liquid composition containing two types of polymerizable compounds (compound mixture) represented by Chemical Formula 1, one type of polymerizable compound not satisfying Chemical Formula 1, and two types of solvents (solvent mixtures), the solubility is determined using a mixture of 10 g of compound mixture and the polyemrizable compound not satisfying Chemical Formula 1 or Chemical Formula 2 and 1 g of the solvent mixture in the polymerizable compound based on the monomer ratio.

Relationship 2 can also be transformed into Relationship 2′.

0≤Mixing ratio Y−Solvent soluble point≤21 Relationship 2′

The liquid composition of the second aspect can form a resin layer with high porosity based on the phase separation rate under Formula 2 or Formula 2′. As a result, it is possible to suppress volume shrinkage during the curing of the liquid composition, thereby forming a high-quality resin layer.

Furthermore, as the “Mixing ratio Y−Solvent soluble point” in Relationship 2′ approaches zero, the curling development due to volume shrinkage can be further reduced.

### Method of Manufacturing Liquid Composition

There are no particular limitations on the method of producing the liquid composition of the present disclosure, and it can be appropriately selected depending on the purpose. The liquid composition is preferably produced through processes such as mixing polymerizable compounds, mixing polymerizable compounds with a solvent, dissolving a polymerization initiator in the solvent, dissolving a non-linkable resin in a liquid composition, and stirring into a uniform solution.

### Insulating Resin Layer

The insulating resin layer is formed by curing a liquid composition and has a porous structure.

Note that the liquid composition is the same as described in the section on Liquid Composition, so redundant descriptions are omitted.

Such an insulating resin layer with a porous structure is unlikely to experience residual stress due to volume shrinkage, which helps to minimize curling. This structure is particularly effective for forming an insulating resin layer with an average thickness of at least 100 μm.

The porous structure is preferably a co-continuous structure with a framework formed of a resin.

The term “co-continuous structure” refers to a structure in which two or more materials or phases each have a continuous structure and do not form an interface. In the present embodiment, it refers to a structure where both the resin phase and the void phase are three-dimensional, branched, networked continuous phases.

These structures can be formed through polymerization-induced phase separation (for example, see Japanese Unexamined Patent Application Publication No. 2003-191628, WO 97/044363 A1, Japanese Unexamined Patent Application Publication No. 2005-298757, Japanese Examined Patent Application Publication No. 2010-513589, Japanese Unexamined Patent Application Publication No. 2001-163907, and Japanese Unexamined Patent Application Publication No. 2001-138504).

### Polymerization-Induced Phase Separation

The term “polymerization-induced phase separation” refers to the state in which, before polymerization begins, the polymerizable compound and the solvent are mutually soluble, but after the polymerization starts, the resulting polymer (resin) and the solvent become insoluble, leading to phase separation. Although there are other methods of obtaining a porous structure through phase separation, the co-continuous porous structure obtained through polymerization-induced phase separation has the advantage of high resistance to chemicals and heat. Additionally, compared to other methods, it offers the benefits of a shorter process time and easier surface modification.

Next, the process for forming a porous structure using polymerization-induced phase separation with a liquid composition containing a polymerizable compound will be explained. The polymerizable compound undergoes a polymerization reaction upon exposure to light or other stimuli to form a resin. During this process, solubility of the growing resin in the solvent decreases. As a consequence, phase separation occurs between the resin and the solvent. Eventually, the resin forms a co-continuous porous structure where the solvent or other materials fill the pores, with the resin forming the skeletal framework. Upon drying, the solvent is removed, leaving behind a porous resin with a three-dimensional networked co-continuous structure.

Considering this polymerization-induced phase separation, the liquid composition, as a preferred form of ink, contains a mixture of a polymerizable compound (monomer) and a solvent, where the resin formed after polymerization is insoluble in the solvent or does not form a gel or sol.

As a method to confirm that the insulating resin layer has a co-continuous structure with continuous pores, for example, one could use scanning electron microscopy (SEM) to observe the cross-section of the insulating resin layer and verify the continuity of the connections between the pores.

### Example of Image Observation Method Using Scanning Electron Microscopy (SEM)

First, the insulating resin layer is osmium stained and then subjected to vacuum impregnation with epoxy resin. The internal cross-section structure is then cut out using a focused ion beam (FIB) and observed using a scanning electron microscope (SEM).

There are no particular restrictions on the porosity of the insulating resin layer, and it can be appropriately selected according to the purpose, A porosity of 30 or more percent is preferred, and 50 or more percent is even more preferable. Additionally, a porosity of at most 90 percent is preferred, and at most 85 percent is even more preferable.

A porosity of at least 30 percent in the insulating resin layer is preferred, as it helps to alleviate the pressure on the solid electrolyte layer from the insulating resin layer during the pressing process after the formation of the solid electrolyte layer.

A porosity of at most 90 percent is desirable for the insulating resin layer to enhance its strength, ensuring adequate shape retention after the pressing process.

The porosity of the insulating resin layer can be measured using the method described in the section “Example of Image Observation Method Using Scanning Electron Microscopy (SEM).”

The air permeability of the insulating resin layer is not particularly limited and can be appropriately selected according to the purpose. Preferably, it is not more than 1,000 seconds/100 mL, more preferably not more than 500 seconds/100 mL, and even more preferably not more than 300 seconds/100 mL.

Air permeability is measured in accordance with JIS P8117 (Paper and board-Determination of air permeance and air resistance (medium range)—Gurley method) and can be measured using, for example, a Gurley densometer (available from Toyo Seiki Seisaku-Sho, Ltd.). As one example, it may be determined that the pores are interconnected or continuous if the air permeability is not more than 1,000 seconds/100 mLs.

The cross-sectional shape of the pores in the insulating resin layer is not particularly limited and can be appropriately selected according to the purpose. Examples include, but are not limited to, substantially circular, elliptical, or polygonal shapes. The size of the pores refers to the length of the longest part of the cross-sectional shape in the insulating resin layer. The size of the pores in the insulating resin layer can be determined, for example, from cross-section images taken using a scanning electron microscope (SEM).

The size of the pores in the insulating resin layer is not particularly limited and can be appropriately selected according to the purpose. Preferably, the ratio of the pore size to the median diameter of the solid electrolyte contained in the liquid composition for forming the solid electrolyte layer (liquid composition for solid electrolyte layer) applied on the insulating resin layer is less than 1, and more preferably 0.8 or less.

If the pore size in the insulating resin layer is larger than the median diameter of the solid electrolyte, the solid electrolyte is more likely to become trapped within the pores of the insulating resin layer. An insulating resin layer with a pore size smaller than the median diameter of the solid electrolyte can form a structure that minimizes the inclusion of the solid electrolyte within the insulating resin layer. This structure is advantageous for pressure distribution during pressing and for alleviating the pressure exerted by the insulating resin layer on the solid electrolyte layer.

There are no particular limitations on the methods of controlling the pore size and porosity of the insulating resin layer, and they can be appropriately selected according to the purpose. Examples include, but are not limited to, adjusting the content of the polymerizable compound in the liquid composition, adjusting the content of the solvent in the liquid composition, and adjusting the irradiation conditions of the actinic ray.

There are no particular limitations on the volume resistivity of the insulating resin layer, and it can be appropriately selected according to the purpose. It is preferable for the volume resistivity to be at least 10¹² Ω·cm. Additionally, it is preferable for the resin layer to be free of conductive paths even if conductive fillers or similar additives are added.

### Electrode for Electrochemical Element

The electrode for an electrochemical element of the present disclosure includes a substrate, an electrode composite layer disposed on the substrate, and an insulating resin layer disposed on the outer periphery of the electrode composite layer. The insulating resin layer is formed by curing a liquid composition and has a porous structure.

Note that the liquid composition is the same as described in the section on “Liquid Composition” and the insulating resin layer is the same as described in the section on Insulating Resin Layer, so redundant descriptions are omitted.

In the present specification, the term “electrode” collectively refers to both the negative electrode and the positive electrode, the term “substrate” collectively refers to both the negative electrode substrate and the positive electrode substrate, and the term “electrode composite layer” collectively refers to both the negative electrode composite layer and the positive electrode composite layer.

Furthermore, when the first electrode is a negative electrode, the second electrode refers to a positive electrode, and when the first electrode is a positive electrode, the second electrode refers to a negative electrode.

### Electrode Laminate

The electrode for an electrochemical element of the present disclosure can be suitably applied to an electrode laminate.

The electrode for an electrochemical element of the present disclosure includes a substrate, an electrode composite layer disposed on the substrate, an insulating resin layer disposed on the outer periphery of the electrode composite layer, and a solid electrolyte layer disposed on the electrode composite layer and the insulating resin layer. The insulating resin layer is formed by curing a liquid composition and has a porous structure.

Note that the liquid composition is the same as described in the section on Liquid Composition and the insulating resin layer is the same as described in the section on Insulating Resin Layer, so redundant descriptions are omitted.

Embodiments of the present disclosure is described with reference to the drawings. The present disclosure is not limited to these embodiments.

In each drawing, the same components may be denoted by the same reference numerals (symbols) and redundant description may be omitted. In addition, the present disclosure is not limited to the number, position, and shapes of the embodiments described above and those can be suitably selected to suit to implementing the present disclosure.

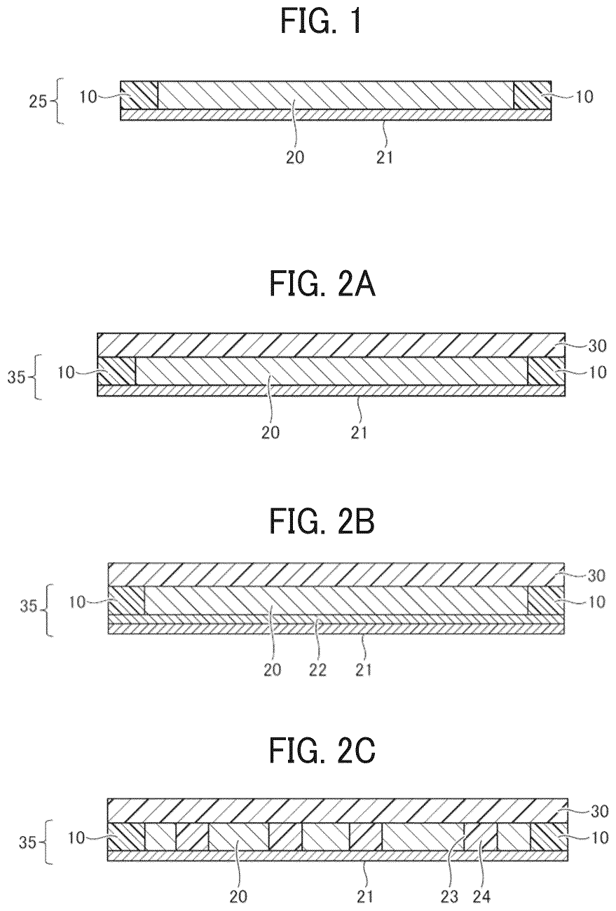

FIG. 1 is a schematic cross-sectional diagram illustrating an electrode for an electrochemical element according to one embodiment of the present disclosure. An electrode 25 for an electrochemical element includes a first substrate 21, a first electrode composite layer 20 disposed on the first substrate 21, and an insulating resin layer 10 disposed on the outer periphery of the first electrode composite layer 20.

Note that FIG. 1 illustrates a configuration in which the electrode composite layer 20 and the insulating resin layer 10 are provided on one side of the first substrate 21, but the electrode composite layer 20 and the insulating resin layer 10 may be provided on both opposing sides of the first substrate 21.

FIG. 2A is a schematic diagram illustrating a cross sectional view of an electrode laminate according to a different embodiment of the present disclosure. FIG. 2B is a schematic diagram illustrating a cross sectional view of an electrode laminate according to another embodiment of the present disclosure. FIG. 2C is a schematic diagram illustrating a cross sectional view of an electrode laminate according to yet another embodiment of the present disclosure. The electrode laminate 35 includes a first substrate 21, a first electrode composite layer 20 disposed on the first substrate 21, an insulating resin layer 10 disposed on the outer periphery of the first electrode composite layer 20, and a solid electrolyte layer 30 disposed on the first electrode composite layer 20 and the insulating resin layer 10.

Note that FIGS. 2A to 2C illustrate the configuration in which the electrode composite layer 20, the insulating resin layer 10, and the solid electrolyte layer 30 are provided on one side of the first substrate 21, but the electrode composite layer 20, the insulating resin layer 10, and the solid electrolyte layer 30 may be provided on both opposing sides of the first substrate 21.

Furthermore, as illustrated in FIG. 2B, an adhesive layer 22 containing a metal that forms an alloy with lithium may be provided between the first substrate 21 and the first electrode composite layer 20.

### Substrate

The substrate is not particularly limited as long as it has electronic conductivity and is stable with respect to the applied potential. It can be appropriately selected according to the purpose. Examples include, but are not limited to, aluminum foil, copper foil, stainless steel foil, titanium foil, etched foil with fine holes created by etching such foil, carbon-coated foil with a surface layer coated with a carbon-containing resin layer, and perforated substrates used in lithium-ion capacitors.

### Electrode Composite Layer

There are no particular limitations on the electrode composite layer (hereinafter sometimes referred to as an active material layer), and it can be appropriately selected according to the purpose. For example, it may contain an active material (negative electrode active material or positive electrode active material) and it may optionally furthermore contain conductive additives, binders, dispersants, and solid electrolytes, and other components.

If the solid electrolyte layer is a sulfide solid electrolyte layer, the cured product (insulating resin layer) of the liquid composition of the present disclosure can minimize the degradation of the ion conductivity of the sulfide solid electrolyte layer. Therefore, it is preferable that the electrode composite layer in an electrode or laminar electrode for an electrochemical element contain the active material and the sulfide solid electrolyte.

The electrode composite layer may have an opening 23 as illustrated in FIG. 2C.

The number of openings 23 is preferably one or more, and more preferably multiple.

The openings 23 may penetrate the electrode composite layer from the surface of the electrode composite layer to the surface of the substrate, or it may not penetrate to the surface of the substrate.

The openings 23 may be hollow or filled with a material 24. When the openings 23 are filled with the material 24, the material 24 may be a single substance or a mixture of two or more substances, but in either case, the material 24 should be different in nature (compound or composition) from the material constituting the electrode composite layer. The material 24 preferably contains a solid electrolyte of the solid electrolyte layer to improve ion conductivity, and more preferably has the same composition as the solid electrolyte layer.

An electrode composite layer with the openings 23 can be suitably manufactured using inkjet as an electrode composite layer forming device because coating control is easy.

### Active Material

The active material can be either a positive electrode active material or a negative electrode active material. The positive electrode active material or negative electrode active material may be used alone or in combination of two or more.

### Positive Electrode Active Material

There is no particular limitation on the positive electrode active material as long as it is a material capable of reversibly absorbing and releasing alkali metal ions. For example, alkali metal-containing transition metal compounds can be used as the positive electrode active materials.

Specific examples of alkali metal-containing transition metal compounds include, but are not limited to, lithium-containing transition metal compounds such as composite oxides containing lithium and one or more elements selected from the group consisting of cobalt, manganese, nickel, chromium, iron, and vanadium.

Specific examples of lithium-containing transition metal compounds include lithium cobalt oxide, lithium nickel oxide, and lithium manganese oxide.

Alkali metal-containing transition metal compounds may also include polyanion compounds having an XO₄ tetrahedron (where X═P, S, As, Mo, W, Si, etc.) in their crystal structure. Of these, lithium-containing transition metal phosphate compounds such as lithium iron phosphate and lithium vanadium phosphate are preferable in terms of cyclability. Lithium vanadium phosphate is more preferable in terms of lithium diffusion coefficient and output properties.

As for the polyanion compounds, it is preferable that the surface is coated and compounded with conductive additives such as carbon materials to enhance electronic conductivity.

It is preferable for alkali metal-containing transition metal compounds to be at least partially coated with an ion-conductive oxide on their surface. As the ion-conductive oxide, lithium ion-conductive oxides are preferable.

There are no particular limitations on the selection of lithium ion-conductive oxides, which can be selected according to the purpose.

Specific examples include, but are not limited to, oxides represented by Chemical Formula LiₓAO_{y} (where A represents B, C, Al, Si, P, S, Ti, Zr, Nb, Mo, Ta, Sc, V, Y, Ca, Sr, Ba, Hf, Ta, Cr, or W, and x and y are positive numbers).

Specific examples of lithium ion-conductive oxides include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, LiTaO₃, Li₂MoO₄, and Li₂WO₄. Among these, Li₄Ti₅O₁₂, Li₂ZrO₃, or LiNbO₃ is preferable.

Lithium ion-conductive oxides may also be composite oxides. Any combination of lithium ion-conductive oxides may be used as composite oxides, such as Li₄SiO₄—Li₃BO₃ and Li₄SiO₄—Li₃PO₄.

### Negative Electrode Active Material

As for the negative electrode active material, there are no particular limitations as long as it is a material capable of reversibly absorbing and releasing alkali metal ions, and it can be appropriately selected according to a particular application.

For example, carbon materials containing graphite with a graphite-type crystalline structure can be used.

Examples of carbon materials include, but are not limited to, natural graphite, spherical or fibrous artificial graphite, hard carbon (non-graphitizable carbon), and soft carbon (easily graphitizable carbon).

In addition to carbon materials, examples of other materials include, but are not limited to, lithium titanate and titanium oxide.

High-capacity materials such as silicon, tin, silicon alloys, tin alloys, silicon oxide, silicon nitride, and tin oxide can also be suitably used as negative electrode active materials to increase the energy density of lithium-ion batteries.

### Conductive Assistant

The conductive assistant is not particularly limited and can be suitably selected to suit to a particular application. Examples of the conductive assistant include, but are not limited to, carbon black produced by a method such as a furnace method, an acetylene method, and a gasification method, and carbon materials such as carbon nanofibers, carbon nanotubes, graphene, and graphite particles.

Conductive assistants other than the carbon materials include, but are not limited to, metal particles and metal fiber of aluminum. The conductive assistant may be combined with an active material in advance.

The content of the conductive assistant is not particularly restricted and can be adjusted according to the purpose. It is preferable for the content to be at most 10 percent by mass relative to the entire liquid composition for forming the electrode composite layer, with a more preferable range of at most 8 percent by mass.

A content of the conductive assistant of at most 10 percent by mass relative to the entire of the liquid composition for forming the electrode composite layer is suitable for enhancing the stability of the liquid composition for an electrode composite layer.

A content of the conductive assistant of at most 8 percent by mass relative to the entire of the liquid composition for forming the electrode composite layer is suitable for further enhancing the stability of the liquid composition for an electrode composite layer.

### Binder

As long as the binder can bind the negative electrode materials to each other, the positive electrode materials to each other, the negative electrode materials to the negative electrode substrate, and the positive electrode materials to the positive electrode substrate, it is not particularly limited and can be appropriately selected according to the purpose. If the liquid composition for forming the electrode composite layer is used for inkjet discharging, it is preferable that the binder minimally increase the viscosity of the liquid composition for forming the electrode composite layer, to minimize nozzle clogging in the liquid discharging head.

As the binder, polymer compounds can be used. Examples include, but are not limited to, thermoplastic resins such as polyvinylidene fluoride (PVDF), acrylic resin, polyethylene, polypropylene, polyurethane, nylon, polytetrafluoroethylene, polyphenylene sulfide, polyethylene terephthalate, polybutylene terephthalate, polyamide compounds, polyimide compounds, polyamide-imide, ethylene-propylene-butadiene rubber (EPBR), styrene-butadiene rubber (SBR), nitrile butadiene rubber (NBR), isoprene rubber, polyisobutene, polyethylene glycol (PEO), polymethyl methacrylate (PMMA), and polyethylene vinyl acetate (PEVA).

The content of the binder to the active material is not particularly restricted and can be appropriately set depending on the purpose. It is preferable that the content be between 1 percent by mass and 15 percent by mass relative to the entire of the liquid composition for forming the electrode composite layer, with a more preferable range between 3 percent by mass and 10 percent by mass. If the content of the binder relative to the active material is at least 1 percent by mass relative to the entire of the liquid composition for forming the electrode composite layer, it is suitable for strongly binding the active material to the substrate.

### Dispersant

As long as it can improve the dispersibility of the active material within the liquid composition for the electrode composite layer, the dispersant is not particularly restricted.

Examples include, but are not limited to, polymer dispersants such as polyethylene oxide, polypropylene oxide, polycarboxylic acid, naphthalene sulfonic acid formalin condensates, polyethylene glycol, polycarboxylic acid partial alkyl esters, polyether, and polyalkylene polyamine; low molecular weight dispersants such as alkyl sulfonic acid, quaternary ammonium alkylene oxide of higher alcohols, polyvalent alcohol esters, and alkyl polyamines; and inorganic dispersants such as polyphosphate-based dispersants.

### Solid Electrolyte

As long as it is a solid substance that possesses electronic insulation and exhibits ionic conductivity, there are no particular restrictions on the solid electrolyte. Sulfide solid electrolytes and oxide solid electrolytes are preferred to achieve high ionic conductivity.

Examples of sulfide solid electrolytes include, but are not limited to, Li₁₀GeP₂S₁₂ and Li₆PS₅X (X═F, Cl, Br, I) with an argyrodite-type crystal structure.

Examples of oxide solid electrolytes include, but are not limited to, LLZ (Li₇La₃Zr₂O₁₂) with a garnet-type crystal structure, LATP (Li₁₊ₓAlₓTi₂₋ₓ(PO₄)₃) (0.1≤x≤0.4) with a NASICON-type crystal structure, LLT (Li_{0.33}La_{0.55}TiO₃) with a perovskite-type crystal structure, and amorphous UPON (Li_{2.9}PO_{3.3}N_{0.4}).

These solid electrolytes can be used either alone or in combination of two or more types.

As electrolyte materials to be dissolved or dispersed in liquid to form these solid electrolyte layers, examples include, but are not limited to, Li₂S and P₂S₅, which are precursor materials for solid electrolytes, and Li₂S—P₂S₅-based glass, Li₇P₃S₁₁ glass ceramics, which are materials for solid electrolytes.

### Insulating Resin Layer

The insulating resin layer in the electrode for an electrochemical element and the electrode laminate of the present disclosure is arranged on the outer periphery of the electrode composite layer disposed on the substrate. The insulating resin layer may also be arranged on the substrate and on the outer periphery of the substrate.

Embodiment of the present disclosure are described with reference to the drawings. The present disclosure is not limited to these embodiments.

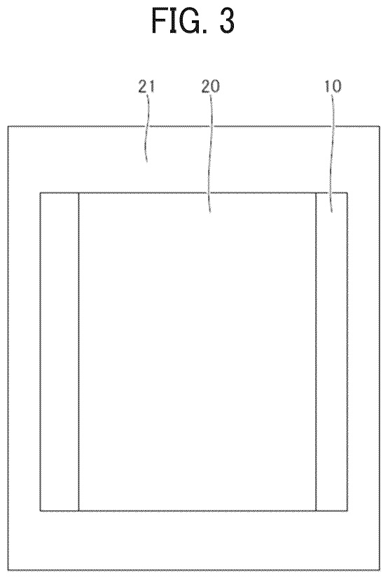

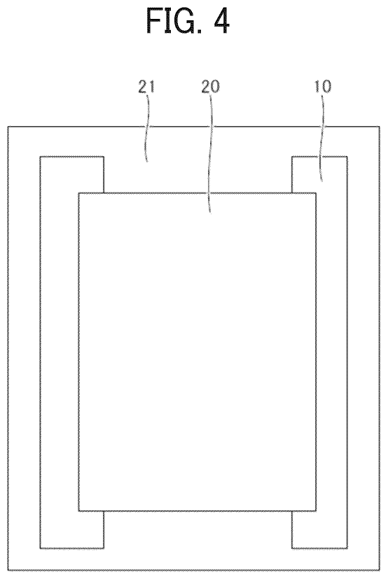

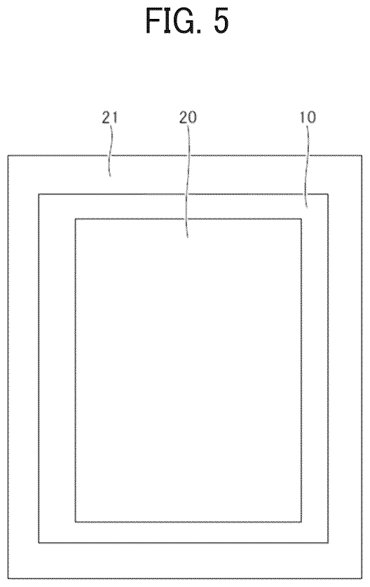

FIG. 3 is a schematic diagram illustrating a top view of an electrode for an electrochemical element according to one embodiment of the present disclosure. FIG. 4 is a schematic diagram illustrating a top view of an electrode for another electrochemical element according to one embodiment of the present disclosure. FIG. 5 is a schematic diagram illustrating a top view of an electrode for yet another electrochemical element according to one embodiment of the present disclosure.

In FIG. 3, the insulating resin layer 10 is provided in contact with two sides of the outer periphery of the first electrode composite layer 20.

In FIG. 4, the insulating resin layer 10 is provided in contact with the two long sides of the outer periphery of the first electrode composite layer 20, as well as to the two corners of those long sides.

In FIG. 5, the insulating resin layer 10 is provided continuously in contact with all four sides of the outer periphery of the first electrode composite layer 20. The insulating resin layer may also be provided in contact with the sides in a discontinuous manner.

In the present specification, “arranged on the outer periphery of the electrode composite layer” means that the insulating resin layer may be arranged on at least two sides of the outer periphery of the electrode composite layer, on three sides of the outer periphery of the electrode composite layer, or on all four sides of the outer periphery of the electrode composite layer. Additionally, the insulating resin layer may have recesses or notches on any side for the protrusion of electrode tabs.

In the present specification, the phrase “arranged on the outer periphery of the substrate” means that the insulating resin layer may be arranged so as to cover the edge of the substrate, or it may be arranged in such a way that the substrate is exposed, as illustrated in FIGS. 3 to 5.

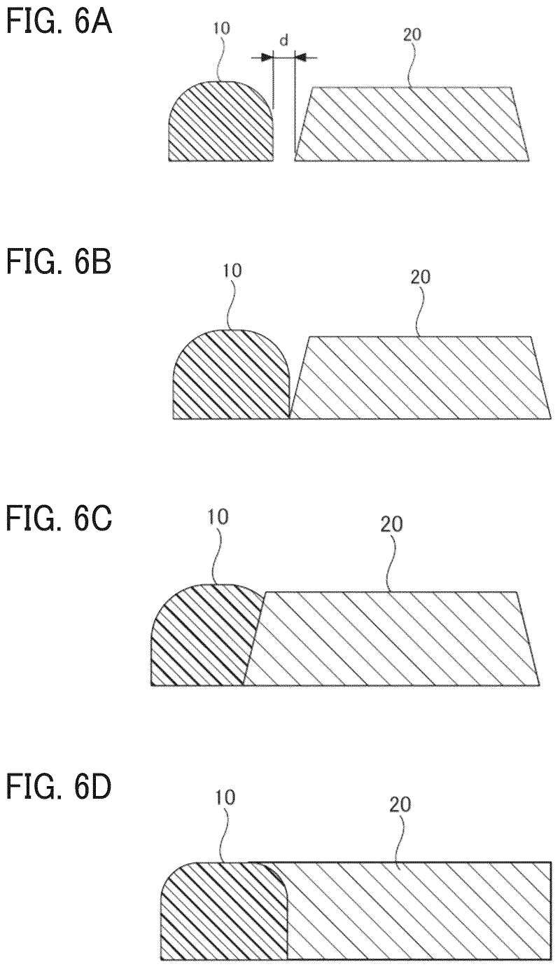

FIG. 6A is a schematic diagram illustrating a cross sectional view (part 1) of a positional relationship between the insulating resin layer and electrode composite layer in an electrode for electrochemical element according to an embodiment of the present disclosure. FIG. 6B is a schematic diagram illustrating a cross sectional view (part 2) of a positional relationship between the insulating resin layer and electrode composite layer in an electrode for electrochemical element according to an embodiment of the present disclosure. FIG. 6C is a schematic diagram illustrating a cross sectional view (part 3) of a positional relationship between the insulating resin layer and electrode composite layer in an electrode for electrochemical element according to an embodiment of the present disclosure. FIG. 6D is a schematic diagram illustrating a cross sectional view (part 4) of a positional relationship between the insulating resin layer and electrode composite layer in an electrode for electrochemical element according to an embodiment of the present disclosure.

The insulating resin layer 10 may be spaced apart from the first electrode composite layer 20, as illustrated in FIG. 6A, or it may be in contact with the first electrode composite layer 20, as illustrated in FIGS. 6B to 6D. Among these configurations, it is preferable for the insulating resin layer 10 to be in contact with the first electrode composite layer 20.

In the case in which the insulating resin layer 10 is in contact with the first electrode composite layer 20, the facing surfaces of the insulating resin layer 10 and the first electrode composite layer 20 may be partially in contact, as illustrated in FIG. 6B, or they may be in full contact, as illustrated in FIGS. 6C to 6D.

If the first electrode composite layer 20 is provided after the formation of the insulating resin layer 10, the first electrode composite layer 20 overlaps with the insulating resin layer 10, as illustrated in FIG. 6C. Similarly, if the insulating resin layer 10 is provided after the formation of the first electrode composite layer 20, the insulating resin layer 10 overlaps with the first electrode composite layer 20, as illustrated in FIG. 6D.

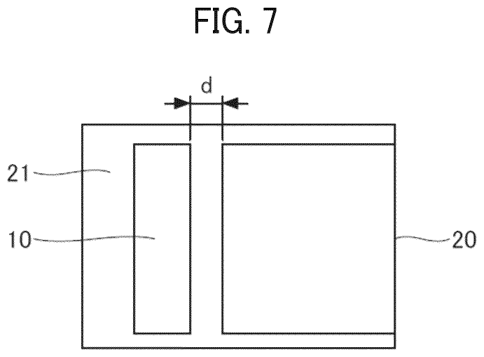

FIG. 7 is a schematic diagram illustrating a top view of a positional relationship between the insulating resin layer and electrode composite layer in an electrode for electrochemical element according to an embodiment of the present disclosure.

If the insulating resin layer 10 and the first electrode composite layer 20 are spaced apart, a distance d between the insulating resin layer 10 and the first electrode composite layer (the distance between the outer periphery of the first electrode composite layer 20 and the insulating resin layer) is defined as illustrated in FIG. 7. That is, if the insulating resin layer and the first electrode composite layer 20 are adjacent, the distance is d=0, and the distance d between the insulating resin layer and the electrode composite layer is defined as the distance between the arrows illustrated in FIG. 7. In cases where the insulating resin layer overlaps the electrode composite layer, as illustrated in FIGS. 6C and 6D, or where the electrode composite layer overlaps the insulating resin layer, a negative value is used to represent this distance.

There are no particular restrictions on the distance d between the insulating resin layer 10 and the first electrode composite layer 20 (the distance between the outer periphery of the first electrode composite layer 20 and the insulating resin layer), and it can be appropriately selected based on the purpose. It is preferable for the distance to be at most 10 mm, more preferably at most 5 mm, and even more preferably at most 1 mm.

A distance d between the insulating resin layer 10 and the first electrode composite layer 20 of at most 10 mm makes it easier for the insulating resin layer and the electrode composite layer to come into contact after a pressing process, suitably leading to the formation of a uniform solid electrolyte layer on the insulating resin layer and the electrode composite layer. Moreover, when the solid electrolyte layer is pressed, it is preferable because uniform pressure can be applied to the solid electrolyte layer.

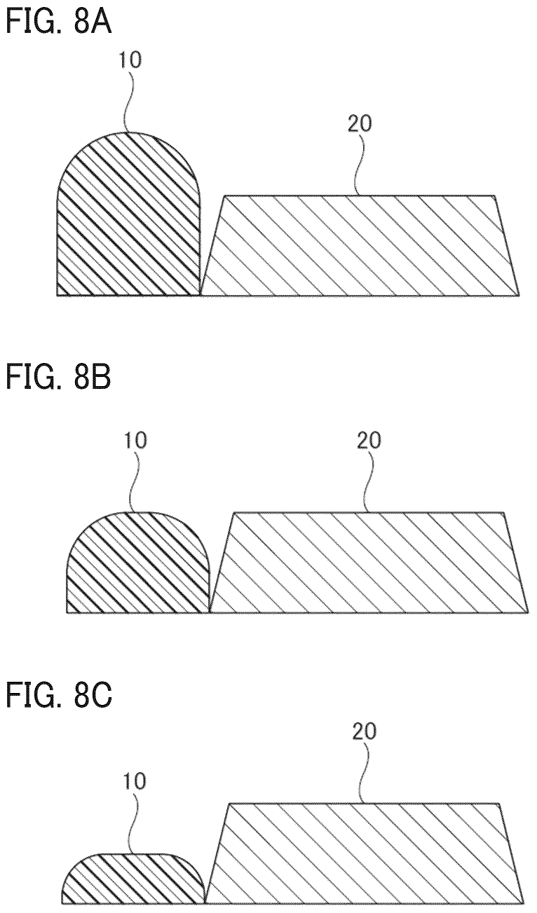

FIG. 8A is a schematic diagram illustrating a cross sectional view (part 1) of a relationship of the average thickness between the insulating resin layer and electrode composite layer in an electrode for electrochemical element according to an embodiment of the present disclosure. FIG. 8B is a schematic diagram illustrating a cross sectional view (part 2) of a relationship of the average thickness between the insulating resin layer and electrode composite layer in an electrode for electrochemical element according to an embodiment of the present disclosure. FIG. 8C is a schematic diagram illustrating a cross sectional view (part 3) of a relationship of the average thickness between the insulating resin layer and electrode composite layer in an electrode for electrochemical element according to an embodiment of the present disclosure.

There are no particular restrictions on the relationship between the average thickness A of the electrode composite layer and the average thickness B of the insulating resin layer in the electrode laminate relating to the present disclosure, and the thicknesses can be appropriately selected depending on the purpose. For example, as illustrated in FIGS. 8A to 8C, A<B, A=B, or A>B may all be acceptable. Among these, A=B or A<B is preferable.

There are no particular restrictions on the average thickness of the insulating resin layer, and it can be appropriately selected according to various conditions such as the average thickness of the electrode composite layer. It is preferably 1.0 μm to 150.0 μm, and more preferably 10.0 μm to 100.0 μm.

An average thickness of the insulating resin layer of at least 10.0 μm can suitably distribute the pressure load during pressing and prevent short circuits between the positive and negative electrodes.

If the average thickness of the insulating resin layer is at most 100.0 μm, it is possible to manufacture an electrochemical element with high density and excellent battery characteristics.

There are no particular restrictions on the ratio (B/A) of the average thickness B of the insulating resin layer to the average thickness A of the electrode composite layer in the electrode laminate of the present disclosure, and it can be appropriately selected depending on the purpose. It is preferably 0.97 to 1.03, and more preferably 0.98 to 1.02.

There are no particular restrictions on the method of measuring the average thickness A of the electrode composite layer and the average thickness B of the insulating resin layer, and it can be appropriately selected depending on the purpose. For example, the thickness at three or more arbitrary points can be measured, and the average value can be calculated.

Since the insulating resin layer in the electrode laminate relating to the present disclosure has a porous structure, the thickness of the electrode composite layer and the insulating resin layer can be easily and precisely controlled through pressing.

Moreover, since the insulating resin layer can be formed by coating and polymerization-induced phase separation methods, the thickness can be easily controlled. If the insulating resin layer has a co-continuous structure, it can efficiently disperse the pressure generated during pressing, preventing issues such as damage to the insulating resin layer or unevenness regarding height, thus ensuring the production of a high-quality insulating resin layer.

There are no particular restrictions on the compression ratio of the insulating resin layer (after pressing at 500 MPa for 5 minutes), and it can be appropriately selected depending on the purpose. It is preferably between 1 percent and 50 percent, and more preferably between 5 percent and 20 percent.

A compression ratio of at most 50 percent enhances the strength of the insulating resin layer, ensuring adequate shape retention after the pressing process.

A compression ratio of at least 1 percent of the insulating resin layer alleviates the pressure on the solid electrolyte layer from the insulating layer during the pressing process after the solid electrolyte layer is formed.

### Solid Electrolyte Layer

The solid electrolyte for the solid electrolyte layer can be appropriately selected from the materials described as the solid electrolyte for the electrode composite layer.

The cured product (insulating resin layer) of the liquid composition of the present disclosure can minimize the deterioration of the ion conductivity of the sulfide solid electrolyte layer. Therefore, it is preferable that the solid electrolyte layer be a sulfide solid electrolyte layer containing a sulfide solid electrolyte.

The solid electrolyte layer may contain a binder. Examples include, but are not limited to, thermoplastic resins such as polyvinylidene fluoride (PVDF), acrylic resin, styrene-butadiene rubber, polyethylene, polypropylene, polyurethane, nylon, polytetrafluoroethylene, polyphenylene sulfide, polyethylene terephthalate, polybutylene terephthalate, polyamide compounds, polyimide compounds, polyamide-imide, ethylene-propylene-butadiene rubber (EPBR), styrene-butadiene rubber (SBR), nitrile-butadiene rubber (NBR), polymethyl methacrylate (PMMA), polybutyl methacrylate (PBMA), isoprene rubber, polyisobutene, polyethylene glycol (PEO), and polyethylene vinyl acetate (PEVA).

### Method of Manufacturing Electrode for Electrochemical Element and Apparatus for Manufacturing Electrode for Electrochemical Element

The method of manufacturing an electrode for electrochemical elements relating to the present disclosure includes forming an insulating resin layer, forming an electrode composite layer, and other optional processes.

The apparatus for manufacturing an electrode for an electrochemical element of the present disclosure includes a storage container, a device for forming an insulating resin layer, a device for forming an electrode composite layer, a device for removing the first solvent and the second solvent simultaneously, and other optional devices.

### Storage Container

The storage container includes a liquid composition for forming an insulating resin layer and a vessel containing the liquid composition.

Specific examples of the vessel include, but are not limited to, a glass bottle, a plastic vessel, a plastic bottle, a stainless steel bottle, a 18-liter drum, and a drum.

Process of Forming Insulating Resin Layer and Device for Forming Insulating Resin Layer

The process of forming an insulating resin layer is to form an insulating resin layer on a substrate. The process of forming an insulating resin layer preferably includes a liquid composition applying process and a liquid composition curing process.

The device for forming an insulating resin layer is to form an insulating resin layer on a substrate. The device for forming an insulating resin layer preferably includes a liquid composition applying device and a liquid composition curing device.

The process of forming an insulating resin layer can be suitably carried out by the device for forming an insulating resin layer, the liquid composition applying process can be suitably carried out by the liquid composition applying device, and the liquid composition curing process can be suitably carried out by the liquid composition curing device.

### Process of Applying Liquid Composition and Device for Applying Liquid Composition

In the liquid composition application, a liquid composition is applied to a substrate.

The liquid composition applying device applies the liquid composition accommodated in the storage container to a substrate.

The process of applying a liquid composition and the device for applying a liquid composition are not particularly limited and can be suitably selected to suit to a particular application. For example, the spin coating method, the casting method, the micro gravure coating method, the gravure coating method, the bar coating method, the roll coating method, the wire bar coating method, the dip coating method, the slit coating method, the capillary coating method, the spray coating method, the nozzle coating method, the gravure printing method, the screen printing method, the flexographic printing method, the offset printing method, the reverse printing method, and the inkjet printing method can be executed by their corresponding printing devices. Of these, inkjet printing is preferable to form an insulating resin layer with precision.

### Process of Curing Liquid Composition and Device for Curing Liquid Composition

The process of curing a liquid composition involves applying heat or light to the liquid composition to cure it.

The device for curing a liquid composition applies heat or light to the liquid composition to cure it.

By applying heat or light to the liquid composition, the polymerizable compound within the liquid composition undergo polymerization and polymerization-inducing phase separation, resulting in an insulating resin layer with a porous structure.

The light used in the process of curing a liquid composition and the device for curing a liquid composition is preferably an actinic ray.

This ray may include any type of actinic radiation that can provide the energy necessary to promote the polymerization reaction of the polymerizable compounds in the liquid composition and is not particularly limited. Examples include, but are not limited to, ultraviolet (UV) rays, electron beams, alpha rays, beta rays, gamma rays, and X-rays. Among these, ultraviolet rays are preferred. Note that in the case of using a particularly high-energy light source, polymerization reactions can be facilitated even without the use of a polymerization initiator.

There are no particular restrictions on the irradiation intensity of the actinic rays, and it can be appropriately selected according to the intended purpose. It is preferably at most 1 W/cm², more preferably at most 300 mW/cm², and even more preferably at most 100 mW/cm².

An excessively low irradiation intensity of the actinic rays can lead to excessive progression of polymerization-induced phase separation, causing variations and coarsening of the porous structure, and longer irradiation times may reduce productivity. Therefore, it is preferably at least 10 mW/cm², and more preferably at least 30 mW/cm².

### Electrode Composite Layer Forming Process and Electrode Composite Layer Forming Device

The process of forming an electrode composite layer is to form an electrode composite layer on a substrate.

The device for forming an electrode composite layer is to form an electrode composite layer on a substrate.

There are no particular limitations on the electrode composite layer forming process or device, and they can be appropriately selected according to the purpose. For example, one can use a method where a dispersion, obtained by dispersing substances such as powdery active materials, binders, and conductive materials in a liquid, is applied onto a substrate, fixed, and dried. In this process, application methods such as spraying, dispensing, die coating, or dip coating can be suitably employed.

### Other Processes and Other Devices

The other optional process relating to the method of manufacturing an electrode for an electrochemical element is not particularly limited and it can be suitably selected to suit to a particular application unless it has an adverse impact on the effects of the present disclosure. It includes, for example, a process of solvent removing.

The other optional device relating to the device for manufacturing an electrode for an electrochemical element is not particularly limited and it can be suitably selected to suit to a particular application unless it has an adverse impact on the effects of the present disclosure. It includes, for example, a device for removing solvents.

### Solvent Removing Process and Solvent Removing Device

The solvent removing process is to remove the solvent from the insulating resin layer.

The solvent removing device is to remove the solvent from the insulating resin layer.

No particular specific restrictions apply to the solvent removal process or the device used for it, and they may be selected as appropriate based on the purpose. One method of removing solvent from the insulating resin layer is heating. In this case, it is preferable to heat under reduced pressure, as this promotes solvent removal and reduces the amount of residual solvent in the insulating resin layer.

Heating can be done using a stage, or a heating mechanism other than a stage may be used. The heating mechanism may be installed on either the upper or lower side of the substrate, or multiple heating mechanisms may be installed. There are no particular restrictions on the heating mechanism; examples include, but are not limited to, resistance heaters, infrared heaters, and fan heaters. There is no particular limit to the heating temperature, but in terms of energy use, it is preferably between 70 degrees Celsius and 150 degrees Celsius.

In the method of manufacturing electrodes for electrochemical devices, there are no particular restrictions on the order of the insulating resin layer forming process and the electrode composite layer forming process. Specifically, the electrode composite layer forming process may be performed before the insulating resin layer forming process, with the insulating resin layer being formed around the outer periphery of the electrode composite layer after its formation. In this case, the method of manufacturing electrodes for electrochemical devices involves performing the electrode composite layer forming process, the insulating resin layer forming process, and then the solvent removal process in that order.

Similarly, the electrode composite layer forming process may be performed after the insulating resin layer forming process, with the insulating resin layer being formed around the outer periphery of the substrate, and then the electrode composite layer being formed inside the insulating resin layer. In this case, the method of manufacturing electrodes for electrochemical devices involves performing the insulating resin layer forming process, the electrode composite layer formation process, and then the solvent removal process in that order.

### Method of Manufacturing Electrode Laminate and Device for Manufacturing Electrode Laminate

The method of manufacturing electrode laminate according to the present disclosure includes the insulating resin layer forming process, the electrode composite layer forming process, and the solid electrolyte layer forming process. Additionally, it may optionally include a pressing process and other processes.

The device for manufacturing electrode laminate according to the present disclosure preferably includes a accommodating unit, an insulating resin layer forming device, an electrode composite layer forming device, and a solid electrolyte layer forming device. It may optionally also include pressing device and other devices.

Note that the storage container, the insulating resin layer forming process, the insulating resin layer forming device, the electrode composite layer forming device, the electrode composite layer forming device, other processes, and other devices are similar to those described in the sections on the method of manufacturing electrodes for electrochemical devices and the device for manufacturing electrodes for electrochemical devices. Therefore, redundant descriptions are omitted.

### Pressing Process and Pressing Device

The pressing process is to press the electrode composite layer and insulating resin layer.

The pressing device is a device to press the electrode composite layer and insulating resin layer.

The pressing process can be suitably executed by the pressing device.

Regarding the pressing process and device, there are no particular restrictions; it can be performed using commercially available pressure molding equipment. The electrode composite layer and the insulating resin layer are possibly pressed in the substrate direction. Examples include, but are not limited to, uniaxial presses, roll presses, cold isostatic presses (CIP), and hot presses. Among these, cold isostatic presses (CIP), which can apply isotropic pressure, are preferred.

There are no particular restrictions on the timing of the pressing process; it can be appropriately selected according to the objective. For example, the electrode composite layer and the insulating resin layer can be pressed after being formed on the substrate, or the pressing can be done after the solid electrolyte layer has been provided, or at both timings. Carrying out the pressing process after forming the electrode composite layer and the insulating resin layer on the substrate, but before forming the solid electrolyte layer, makes the average thickness of the electrode composite layer and the average thickness of the insulating resin layer approximately equal. This helps to distribute the pressure load, even if high pressure is applied during pressing the solid electrolyte layer provided on the electrode.

Regarding the pressing pressure, there are no particular restrictions, and it can be appropriately selected according to the objective; however, it is preferable to apply a pressure that enables the substrate and the electrode composite layer to be bonded and densification of the electrode composite layer at the same time. More specifically, a pressure between 1 MPa and 900 MPa is preferable, and a range between 250 MPa and 700 MPa is even more preferable.

### Solid Electrolyte Layer Formation and Solid Electrolyte Layer Forming Device

The solid electrolyte layer forming process in the method of manufacturing an electrode laminate involves forming a solid electrolyte layer on the electrode composite layer and the insulating resin layer.

The solid electrolyte layer forming device in the apparatus for manufacturing an electrode laminate refers to the device for forming a solid electrolyte layer on the electrode composite layer and the insulating resin layer.

There are no particular limitations on the method of forming the solid electrolyte layer, and it can be appropriately selected according to the objective. For example, one way of forming the solid electrolyte involves applying a liquid composition containing a solid electrolyte, and optionally a binder, onto the electrode composite layer and the insulating resin layer, followed by drying through solidification.

The method of applying the liquid composition is not particularly limited.

Specific examples include, but are not limited to, liquid discharging methods such as an inkjet method, a spray coating method, and a dispenser method, spin coating, casting, MICROGRAVURE™ coating, gravure coating, bar coating, roll coating, wire bar coating, dip coating, slit coating, capillary coating, nozzle coating, gravure printing, screen printing, flexographic printing, offset printing, and reverse printing.

In the method of manufacturing an electrode laminate, there are no particular restrictions on the order of the insulating resin layer forming process and the electrode composite layer forming process. Specifically, the electrode composite layer forming process may be performed before the insulating resin layer forming process, with the insulating resin layer being formed around the outer periphery of the electrode composite layer after its formation. In that case, the method of manufacturing the electrode laminate is carried out in the following order: the electrode composite layer forming process, the insulating resin layer forming process, the solvent removal process, the pressing process.

Similarly, the electrode composite layer forming process may be performed after the insulating resin layer forming process, with the insulating resin layer being formed around the outer periphery of the substrate, and then the electrode composite layer being formed inside the insulating resin layer. In that case, the method of manufacturing the electrode laminate is carried out in the following order: the insulating resin layer forming process, the solvent removal process, the electrode composite layer forming process, the pressing process, and the solid electrolyte layer forming process.

### Embodiment for Forming Insulating Resin Layer or Electrode Laminate by Directly Applying Liquid Composition to Substrate

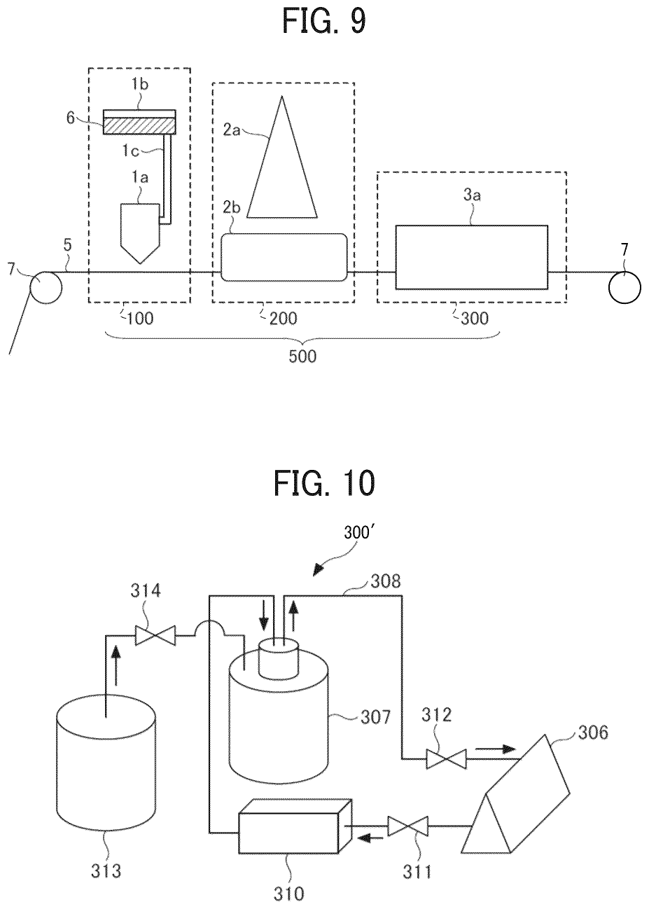

FIG. 9 is a schematic diagram illustrating an example of a device (liquid discharging device) for manufacturing an insulating resin layer to execute the method of manufacturing the electrode laminate relating to the present disclosure.

An insulating resin layer manufacturing device 500 includes a conveyance unit 5, a printing unit 100, a polymerization unit 200, a heating unit 300, and a roller 7.

The conveyance unit 5 conveys a printing substrate at a preset speed in the order of the printing unit 100, the polymerization unit 200, and the heating unit 300.

The printing substrate may have an electrode composite layer thereon, or it may be without an electrode composite layer. If the substrate does not have an electrode composite layer, the electrode composite layer is provided after the formation of the insulating resin layer.

### Printing Unit 100

The printing unit 100 includes a printing device 1a, which is an example of a liquid composition applying device for carrying out liquid composition application on the printing substrate, a storage container 1b that contains the liquid composition 6, and a supply tube 1c that supplies the liquid composition stored in the storage container 1b to the printing device 1a.

The printing unit 100 discharges the liquid composition 6 from the printing device 1a onto the printing substrate, forming the liquid composition into a thin film. The storage container 1b may be configured to be integrated with or detachable from the insulating resin layer manufacturing device. Additionally, the storage container 1b may be designed to add materials to a container that is either integrated with or detachable from the insulating resin layer manufacturing device.

There are no particular limitations on the storage container 1b and supply tube 1c as long as they can stably store and supply the liquid composition 6, and they can be appropriately selected according to the purpose.

It is preferable that the materials constituting the storage container 1b and supply tube 1c have light-shielding properties in the relatively short wavelength regions of ultraviolet and visible light. Such materials are preferred to prevent the liquid composition 6 from initiating polymerization due to exposure to external light.

### Polymerization Unit 200

As illustrated in FIG. 9, in the case of photopolymerization, the polymerization unit 200 includes a light irradiation device 2a, which is an example of a liquid composition curing device for carrying out the liquid composition curing process, and a polymerization inert gas circulation device 2b, which circulates an inert gas for polymerization.

The light irradiation device 2a irradiates the thin film-like liquid composition formed by the printing unit 100 with light in the presence of a polymerization inert gas, initiating photopolymerization to obtain an insulating resin layer precursor.

The light irradiation device 2a is not particularly limited as long as it can initiate and progress the polymerization of compounds in the liquid composition. It can be selected appropriately according to the absorption wavelength of the photopolymerization initiator contained in the liquid composition. Examples include, but are not limited to, ultraviolet light sources such as high-pressure mercury lamps, metal halide lamps, thermal positive electrode tubes, cold positive electrode tubes, and LEDs. However, since light with shorter wavelengths tends to penetrate more deeply, it is preferable to select the light source according to the thickness of the insulating resin layer to be formed.

The polymerization inert gas circulation device 2b reduces the concentration of polymerization-active oxygen in the atmosphere to prevent the inhibition of polymerization reactions of polymerizable compounds near the surface of the liquid composition. Inert gases for polymerization include, for example, nitrogen, carbon dioxide, and argon.

It is preferable to maintain the O₂ concentration in the inert gas below 20 percent (a lower oxygen concentration than in the atmosphere) to achieve a greater inhibition reduction effect. More preferably, the O₂ concentration should be between 0 and 15 percent, and even more preferably between 0 and 5 percent.

Additionally, it is preferable for the polymerization inert gas circulation device 2b to be equipped with a temperature control device to ensure stable polymerization conditions.

The polymerization unit 200 may be a heating device in the case of thermal polymerization. There are no particular limitations on the heating device, and it can be appropriately selected according to the purpose. Examples include, but are not limited to, substrate heating (such as hot plates), IR heaters, and hot air heaters, which may also be used in combination.

Additionally, the heating temperature and time, or the conditions for light irradiation, can be appropriately selected according to the polymerizable compounds contained in the liquid composition and the thickness of the formed film.

There are no particular limitations on the polymerization unit 200, and it can be appropriately selected according to the purpose, such as the polymerization initiator or polymerization method to be used.

For example, a light irradiation device that emits ultraviolet light with a wavelength of 365 nm for 3 seconds can be used in the case of photopolymerization, and a heating device that heats at 150 degrees C. under vacuum for 12 hours can be used in the case of thermal polymerization.

### Heating Unit 300

The heating unit 300 includes a heating device 3a, which is an example of a solvent removal device for carrying out the solvent removal process.

As illustrated in FIG. 9, the heating device 3a heats the insulating resin layer precursor formed by the polymerization unit 200 to dry and remove any remaining solvent. At this time, the solvent removal process may be conducted under reduced pressure.

The heating unit 300 executes a polymerization promotion process of heating the insulating resin layer precursor with the heating device 3a to further accelerate the curing (polymerization) reaction performed in the polymerization unit 200.

Additionally, it carries out an initiator removal process of heating and drying them with the heating device 3a to remove any remaining photopolymerization initiators in the insulating resin layer precursor. These polymerization promotion and initiator removal processes do not need to be conducted simultaneously with the solvent removal process; they may be performed before or after the solvent removal process.

The heating unit 300 also carries out a polymerization completion process, where the insulating resin layer is heated under reduced pressure after the solvent removal process. The heating temperature and time can be appropriately selected according to the boiling point of the solvent contained in the insulating resin layer precursors and the thickness of the formed film.

FIG. 10 is a schematic diagram illustrating another example of a device (liquid discharging device) for manufacturing an insulating resin layer to execute the method of manufacturing an electrode laminate according to one embodiment of the present disclosure.

A liquid discharging device 300′ allows the liquid composition to circulate through a liquid discharging head 306, a liquid discharging head tank 307, and a tube 308 by adjusting a pump 310 and valves 311 and 312.

The liquid discharging device 300′ is equipped with an external tank 313, allowing the liquid composition to be supplied from the external tank 313 to the liquid discharging head tank 307 by adjusting the pump 310 and operating the valves 311, 312, and 314 when the liquid composition in the head tank 307 decreases.

The device for manufacturing the insulating resin layer allows the liquid composition to be discharged precisely onto the targeted areas of an object.

The insulating resin layer manufacturing device 500 may be equipped with a mechanism to cap the nozzle to prevent drying when the liquid composition 6 is not being discharged from the liquid discharging head.

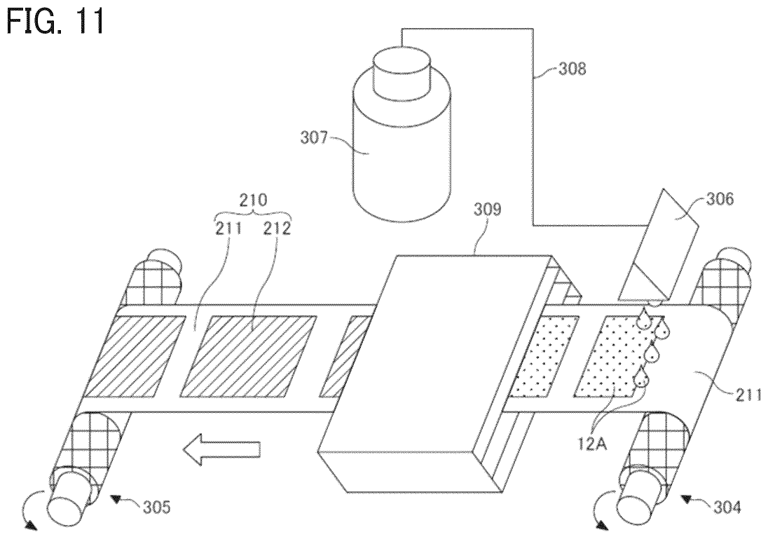

FIG. 11 is a schematic diagram (part 1) illustrating a method of manufacturing an electrode for an electrochemical element according to one embodiment of the present disclosure.

The method of manufacturing an electrode 210 for an electrochemical element, which has an insulating resin layer formed on a substrate, includes a process of sequentially discharging a liquid composition 12A onto a substrate 211 using the liquid discharging device 300′.

First, a slender substrate 211 is prepared. The substrate 211 is then wound around a cylindrical core, with the side where the insulating resin layer 212 is to be formed facing upwards as illustrated in FIG. 11, and is placed between a feed roller 304 and a take-up roller 305. The feed roller 304 and the take-up roller 305 rotate counterclockwise to convey the substrate 211 from right to left in FIG. 11. Then, in the same manner as in FIG. 10, the liquid discharging head 306 positioned above the substrate 211 sequentially discharges droplets of the liquid composition 12A onto the substrate 211, which is conveyed between the feed roller 304 and the take-up roller 305.

Note that two or more of the liquid discharging heads 306 can be positioned in the direction substantially parallel or perpendicular to the conveyance direction of the substrate 211.

Next, the substrate 211, onto which the droplets of liquid composition 12A have been discharged, is conveyed to the polymerization unit 309 by the feed roller 304 and the take-up roller 305. As a result, the liquid composition 12A is polymerized to form the insulating resin layer 212, resulting in an electrode 210 for the electrochemical element with an insulating resin layer on the substrate. Subsequently, the electrode 210 for the electrochemical element is cut to a desired size through processes such as punching.

The polymerization unit 309 may be installed on either the upper or lower side of the substrate 211, or multiple units may be disposed.

The polymerization unit 309 is not particularly limited as long as it does not directly contact the liquid composition 12A, and can be appropriately selected according to the intended purpose. For example, in the case of thermal polymerization, options include resistance heating heaters, infrared heaters, and fan heaters, while in the case of photopolymerization, ultraviolet irradiation devices can be used. Two or more of the polymerization unit 309 can be disposed.

There is no specific limitation to the conditions for heating or light irradiation. It can be selected to suit to a particular application.

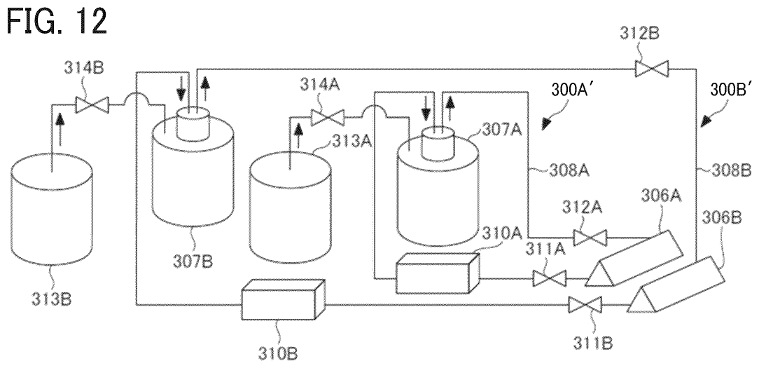

FIG. 12 is a schematic diagram illustrating another example of a device (liquid discharging device) for manufacturing an insulating resin layer to execute the method of manufacturing an electrode laminate according to one embodiment of the present disclosure.

The liquid discharging devices 300A′ and a 300B′ may be used in combination. Specifically, the liquid composition may be supplied from external tanks 313A and 313B connected to liquid discharging head tanks 307A and 307B, respectively, and the liquid discharging heads may include multiple heads 306A and 306B. Additionally, the system may include tubes 308A and 308B, valves 311A, 311B, 312A, 312B, 314A, and 314B, as well as pumps 310A and 310B.

### Embodiment for Forming Insulating Resin Layer or Electrode Laminate by Indirectly Applying Liquid Composition to Substrate

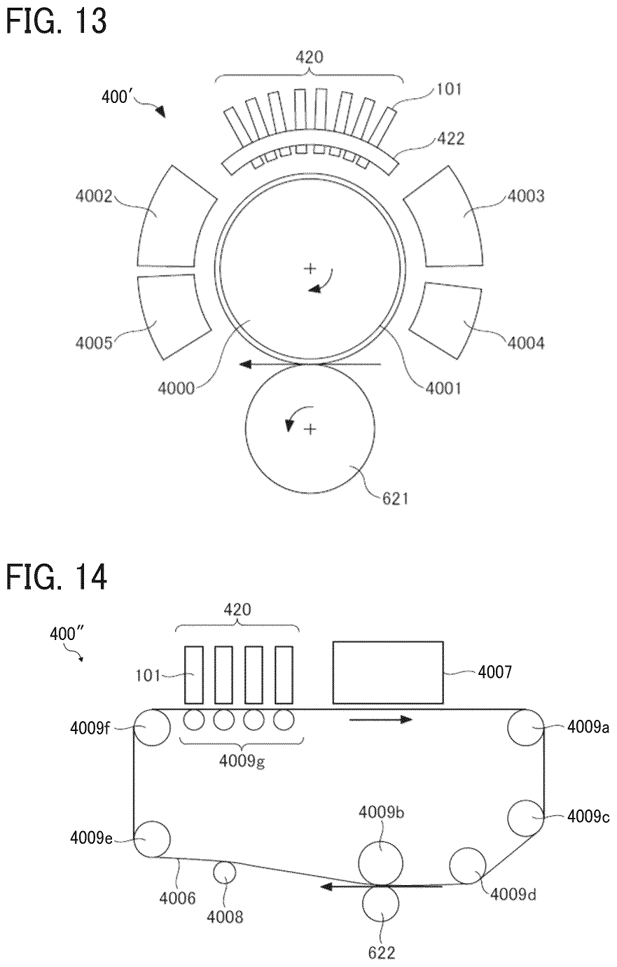

FIG. 13 is a configuration diagram (part 1) illustrating an example of a printing unit in which an inkjet method and a transfer method are adopted as the liquid composition application device in an insulating resin layer manufacturing device according to an embodiment of the present disclosure. In the printing unit illustrated in FIG. 13, a drum-shaped intermediate transfer body is used.

A printing unit 400′ is an inkjet printer that forms an insulating resin layer on a substrate by transferring the liquid composition or the insulating resin layer onto the substrate via an intermediate transfer member 4001.

The printing unit 400′ includes an inkjet unit 420, a transfer drum 4000, a pretreatment unit 4002, an absorption unit 4003, a heating unit 4004, and a cleaning unit 4005.

The inkjet unit 420 includes a head module 422 carrying multiple heads 101.

The heads 101 discharge a liquid composition to the intermediate transfer member 4001 supported by the transfer drum 4000 to form a liquid composition layer on the intermediate transfer member 4001. Each of the heads 101 is a line head. The nozzles thereof are disposed to cover the width of the printing region of the maximally usable substrate. The heads 101 have a nozzle surface formed with nozzles on its lower side, and the nozzle surface faces the surface of the intermediate transfer member 4001 through a minute gap. In the present embodiment, the intermediate transfer member 4001 is configured to move circularly on a circular orbit. The heads 101 are thus radially positioned.

The transfer drum 4000 faces an impression cylinder 621 and forms a transfer nip.

The pretreatment unit 4002 may apply a reaction liquid to the intermediate transfer member 4001 to increase the viscosity of a liquid composition before the heads 101 discharge the liquid composition.

The absorption unit 4003 absorbs the liquid component from the liquid composition on the intermediate transfer member 4001 before transferring.

The heating unit 4004 heats the liquid composition on the intermediate transfer member 4001 before transferring. Heating initializes thermal polymerization of the liquid composition, forming an insulating resin layer. The solvent is also removed, thereby enhancing the transferability to the substrate.

The cleaning unit 4005 cleans the intermediate transfer member 4001 after the transfer process and removes ink and contaminants, such as dust, that remain on the intermediate transfer member 4001.

The outer surface of the impression cylinder 621 is in press contact with the intermediate transfer member 4001, allowing the insulating resin layer on the intermediate transfer member 4001 to be transferred to the substrate when it passes through the transfer nip between the impression cylinder 621 and the intermediate transfer member 4001. The impression cylinder 621 can be configured to include at least one gripping mechanism for holding the front end of the substrate on its outer surface.

FIG. 14 is a configuration diagram (part 2) illustrating another example of a printing unit in which an inkjet method and a transfer method are adopted as the liquid composition application device in an insulating resin layer manufacturing device according to an embodiment of the present disclosure. The printing unit 14 has an intermediate transfer member having an endless belt form.

A printing unit 400″ is an inkjet printer that forms an insulating resin layer on a substrate by transferring the liquid composition or the insulating resin layer onto the substrate via an intermediate transfer belt 4006.

The printing unit 400″ is equipped with an inkjet unit 420, a transfer roller 622, the intermediate transfer belt 4006, a heating unit 4007, a cleaning roller 4008, a drive roller 4009a, a counter roller 4009b, a shape-maintaining roller 4009c, a shape-maintaining roller 4009d, a shape-maintaining roller 4009e, and a shape-maintaining roller 4009f.

The printing unit 400″ discharges liquid droplets of the liquid composition from the heads 101 of the inkjet unit 420 onto the outer surface of the intermediate transfer belt 4006. The liquid composition on the intermediate transfer belt 4006 is heated by the heating unit 4007 and forms an insulating resin layer through thermal polymerization. The insulating resin layer on the intermediate transfer belt 4006 is transferred to the substrate at the transfer nip where the intermediate transfer belt 4006 faces the transfer roller 622. After transfer, the cleaning roller 4008 cleans the surface of the intermediate transfer belt 4006.

The intermediate transfer belt 4006 is stretched over a drive roller 4009a, a counter roller 4009b, multiple shape-maintaining rollers 4009c, 4009d, 4009e, 4009f, and several support rollers 4009g, and moves in the direction indicated by the arrow in FIG. 14. The support rollers 4009g disposed facing the heads 101 maintain the tension of the intermediate transfer belt 4006 when the heads 101 discharge ink droplets.

### Electrochemical Element

The electrochemical element relating to the present disclosure preferably includes an electrode laminate, and may optionally have an outer casing as well.

Note that the electrode laminate is the same as described in the section on Electrode Laminates, so redundant descriptions are omitted.

An embodiment of the electrochemical element relating to the present disclosure is described with reference to the drawings. The present disclosure is not limited to these embodiments.

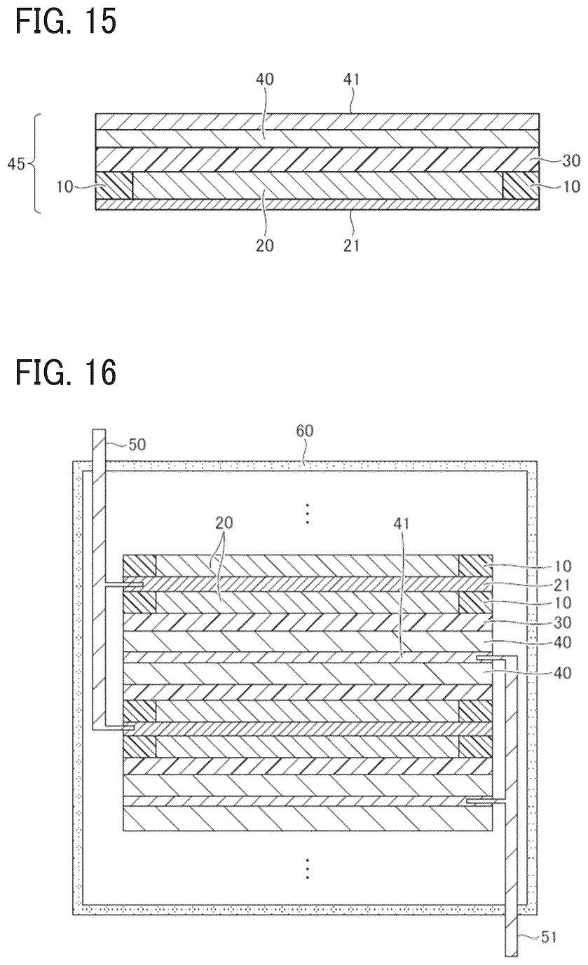

FIG. 15 is a schematic cross-sectional view illustrating the electrochemical element according to one embodiment of the present disclosure. The electrochemical element 45 includes a first substrate 21, a first electrode composite layer 20 disposed on the first substrate 21, an insulating resin layer 10 disposed on the outer periphery of the first electrode composite layer 20, a solid electrolyte layer 30 disposed on the first electrode composite layer and the insulating resin layer 10, a second electrode composite layer 40 disposed on the solid electrolyte layer 30, and a second substrate 41 disposed on the second electrode composite layer 40. The electrochemical element 45 is a single-cell layer, and this can be laminated to form a stacked battery.

Note that FIG. 15 illustrates the configuration in which the electrode composite layer 20, the insulating resin layer 10, and the solid electrolyte layer 30 are provided on one side of the first substrate 21, but the electrode composite layer 20, the insulating resin layer 10, and the solid electrolyte layer 30 may be provided on both opposing sides of the first substrate 21. This configuration may be laminated to form a stacked battery.

FIG. 16 is a schematic cross-sectional view illustrating an example of an state solid battery, which is an electrochemical element according to one embodiment of the present disclosure.

The state solid battery illustrated in FIG. 16 includes a positive electrode (electrode composite layer) 20, a negative electrode (electrode composite layer) 40, a solid electrolyte layer 30, lead wires 50 and 51, and an outer casing 60.

The positive electrode (first electrode composite layer) 20 includes a positive electrode substrate 21 and an insulating resin layer 10 disposed on the positive electrode substrate 21. The lead wire 50 is connected to the positive electrode substrate 21, and the lead wire 51 is connected to the negative electrode substrate 41. The lead wires 50 and 51 are drawn out to the outside of the outer casing 60.

In the state solid battery, the positive electrode (electrode composite layer) 20 and the negative electrode (electrode composite layer) 40 are stacked via the solid electrolyte layer 30, and the positive electrode (electrode composite layer) 20 is disposed on both sides of the negative electrode (electrode composite layer) 40. Note that there is no particular limit on the number of stacks of the positive electrodes (first electrode composite layer) 20 and the negative electrodes (second electrode composite layer) 40. Also, the number of positive electrodes (first electrode composite layers) 20 and negative electrodes (second electrode composite layers) 40 may be the same or different.

As for the outer casing, there is no particular limitation as long as it can seal the electrode laminate, and a known outer casing can be appropriately selected depending on the purpose.

The shape of the electrochemical element is not particularly limited and can be appropriately selected depending on the purpose. For example, it may be a laminate type, cylinder type, or coin type.

In electrochemical devices where short circuits can potentially occur due to dendrite deposition, it is generally common to configure the negative electrode composite layer to be larger than the positive electrode composite layer. In this case, if the positive and negative current collectors are approximately the same size, a surplus area where the positive electrode composite layer is not formed will be present in the region on the positive current collector where it faces the negative electrode composite layer. In term of electrochemical element properties, it is preferable that the insulating resin layer be provided in the surplus area of the positive electrode, that is, at the outer periphery of the positive electrode composite layer. However, if the configuration is such that the negative electrode composite layer is smaller than the positive electrode composite layer in an electrochemical element, it is preferable that the insulating resin layer be provided in the surplus area of the negative electrode, that is, at the outer periphery of the negative electrode composite layer.

### Method of Manufacturing Electrochemical Element and Apparatus for Manufacturing Electrochemical Element

The method for manufacturing an electrochemical element relating to the present disclosure preferably includes an insulating resin layer forming process, an electrode composite layer forming process, a pressing process, a solid electrolyte layer forming process, a device forming process, and an electrode processing process, and may also include other optional processes.

The apparatus for manufacturing an electrochemical element relating to the present disclosure preferably includes an insulating resin layer forming device, an electrode composite layer forming device, a pressing device, a solid electrolyte layer forming device, an element forming device, and an electrode processing device, and may also include other optional devices.

Since the insulating resin layer forming process, insulating resin layer forming device, electrode composite layer forming process, electrode composite layer forming device, pressing process, pressing device, solid electrolyte layer forming process, solid electrolyte layer forming device, other processes, and other devices are the same as those described in the sections on Method of Manufacturing Electrode for Electrochemical Element and Apparatus for Manufacturing Electrode for Electrochemical Element and Method of Manufacturing Electrode Laminate and Apparatus for Manufacturing Electrode Laminate, the repetitive descriptions are omitted.

### Element Forming Process and Element Forming Device

The element forming process is for manufacturing an electrochemical element using an electrode laminate.

The element forming device is for manufacturing an electrochemical element using an electrode laminate.

There are no particular restrictions on the method of manufacturing an electrochemical element using an electrode laminate, and an appropriate, known method of manufacturing an electrochemical element may be selected according to a particular application. For example, it may include at least one of placing counter electrodes, winding or laminating, and housing in a container to form an energy storage element.

Note that the element forming process does not need to include all processes of element forming and may include only a part of the processes involved in element forming.

### Electrode Processing Process and Electrode Processing Device

The electrode processing process is for processing an electrode with a formed insulating resin layer, conducted after the liquid composition application process in the insulating resin layer forming process. The electrode processing process may include at least one of a cutting process, folding process, and laminating process.

The electrode processing device is for processing an electrode with a formed insulating resin layer. The electrode processing device may include at least one of a cutting device, folding device, and laminating device.

For example, the electrode processing device may cut the electrode with a formed insulating resin layer to create an electrode laminate. The electrode processing device may, for example, wind or laminate the electrode laminate with a formed insulating resin layer. The electrode processing device may, for example, include an electrode processing device that performs cutting, accordion folding, laminating, or winding of the electrode laminate with a formed insulating resin layer according to the desired battery format.

The application of the electrochemical device is not particularly limited and it can be suitably selected to suit to a particular application.

Examples include, but are not limited to: mobile objects such as vehicles; and electric devices, such as mobile phones, notebook computers, pen-input personal computers, mobile personal computers, electronic book players, cellular phones, portable facsimiles, portable copiers, portable printers, headphone stereos, video movies, liquid crystal televisions, handy cleaners, portable compact discs (CDs), minidiscs, transceivers, electronic notebooks, calculators, memory cards, portable tape recorders, radios, backup power supplies, motors, lighting devices, toys, game machines, watches, strobes, and cameras. Of these, vehicles and electric devices are preferable.

The mobile objects include, but are not limited to, ordinary vehicles, heavy special cars, small special vehicles, trucks, heavy motorcycles, and ordinary motorcycles.

An embodiment of the mobile object as the electrochemical element relating to the present disclosure is described with reference to the drawings. The present disclosure is not limited to these embodiments.

### Mobile Object

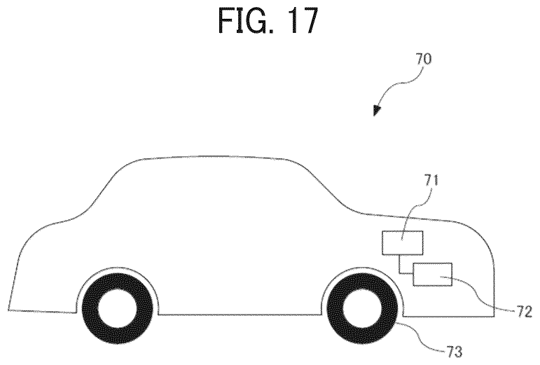

FIG. 17 is a schematic diagram illustrating a mobile object, which is an electrochemical element according to an embodiment of the present disclosure.

A mobile object 70 is an electric vehicle, for example. The mobile object 70 includes a motor 71, an electrochemical device 72, and wheels 73.

The electrochemical device 72 is an electrochemical device relating to the present disclosure. The electrochemical device 72 drives a motor 71 by supplying electricity to the motor 71. The motor 71 driven can drive the wheels 73, and as a result, the mobile object 70 can move.

Since the mobile object 70 is equipped with the electrochemical device 72, it prevents short circuits between the positive and negative electrodes, and is driven by the power from an electrochemical device that has excellent battery properties, allowing the vehicle to move safely and efficiently.

The mobile object 70 is not limited to an electric vehicle; it may be a plug-in hybrid vehicle (PHEV), a hybrid electric vehicle (HEV), and a locomotive or motorcycle that can operate using both a diesel engine and an electrochemical element. Additionally, the mobile object 70 could be a transport robot used in factories, capable of operating with only an electrochemical element or in combination with an engine and an electrochemical element. Furthermore, the mobile object 70 could be a device where not the entire object moves, but only a part of it, such as an assembly robot placed in a factory production line, which can operate using only an electrochemical element or in combination with an engine and an electrochemical element to move an arm or other components.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples and Comparative Examples but is not limited thereto. In the following Examples and Comparative Examples, “parts” represents “parts by mass” and, “percent”, “percent by mass”, unless otherwise specified.

### Manufacturing of Copolymer

### Manufacturing Example 1 of Resin

A total of 1,000 parts by mass of methyl acrylate (available from Tokyo Chemical Industry Co., Ltd.) and 1,000 parts by mass of toluene (available from Tokyo Chemical Industry Co., Ltd.) were stirred for 8 hours at 25 degrees Celsius in a nitrogen atmosphere. After stirring, 3 parts by mass of azobisisobutyronitrile (available from Tokyo Chemical Industry Co., Ltd.) were added, and the mixture was heated and stirred at 100 degrees Celsius to initiate polymerization. At this point, the polymerization reaction was carried out until the weight-average molecular weight reached 50,000, as measured by gel permeation chromatography. After this polymerization reaction, the polymer was purified through a series of operations: (1) reprecipitation using a large amount of methanol, (2) dissolution of the precipitate using ethyl acetate, and (3) reprecipitation using methanol. These operations were repeated three times. The precipitate obtained after reprecipitation was dried under reduced pressure at 80 degrees Celsius, yielding polymethyl acrylate (Mw=50,000).

### Manufacturing Example 2 of Resin

Polyethyl acrylate (Mw=50,000) was obtained in the same manner as in Manufacturing Example 1 of Resin except that ethyl acrylate (available from Tokyo Chemical Industry Co., Ltd.) was used instead of methyl acrylate, and 4 parts by mass of azobisisobutyronitrile was added.

### Manufacturing Example 3 of Resin

Polypropyl acrylate (Mw=50,000) was obtained in the same manner as in Manufacturing Example 1 of Resin except that n-butyl acrylate (available from Tokyo Chemical Industry Co., Ltd.) was used instead of methyl acrylate, and 4 parts by mass of azobisisobutyronitrile was added.

### Manufacturing Example 4 of Resin

Poly-n-butyl acrylate (Mw=18,000) was obtained in the same manner as in Manufacturing Example 1 of Resin except that n-butyl acrylate (available from Tokyo Chemical Industry Co., Ltd.) was used instead of methyl acrylate, and 12 parts by mass of azobisisobutyronitrile was added.

### Manufacturing Example 5 of Resin

Poly-iso-butyl acrylate (Mw=50,000) was obtained in the same manner as in Manufacturing Example 1 of Resin except that iso-butyl acrylate (available from Tokyo Chemical Industry Co., Ltd.) was used instead of methyl acrylate, and 4 parts by mass of azobisisobutyronitrile was added.

### Manufacturing Example 6 of Resin

A poly(n-butyl acrylate-co-methyl methacrylate) random copolymer (Mw=50,000) with a theoretical copolymerization ratio of 50:50 in mass ratio of n-butyl acrylate to methyl methacrylate was obtained in the same manner as in Manufacturing Example 1 of Resin except that 561 parts by mass of n-butyl acrylate and 439 parts by mass of methyl methacrylate (available from Tokyo Chemical Industry Co., Ltd.) were used instead of methyl acrylate.

### Manufacturing Example 7 of Resin

A poly(n-butyl acrylate-co-methyl methacrylate) random copolymer (Mw=50,000) with a theoretical copolymerization ratio of 60:40 in mass ratio of n-butyl acrylate to methyl methacrylate was obtained in the same manner as in Manufacturing Example 1 of Resin except that 657 parts by mass of n-butyl acrylate and 343 parts by mass of methyl methacrylate (available from Tokyo Chemical Industry Co., Ltd.) were used instead of methyl acrylate.

### Manufacturing Example 8 of Resin

A poly(n-butyl acrylate-co-methyl methacrylate) random copolymer (Mw=50,000) with a theoretical copolymerization ratio of 80:20 in mass ratio of n-butyl acrylate to methyl methacrylate was obtained in the same manner as in Manufacturing Example 1 of Resin except that 837 parts by mass of n-butyl acrylate and 163 parts by mass of methyl methacrylate (available from Tokyo Chemical Industry Co., Ltd.) were used instead of methyl acrylate.

### Manufacturing Example 9 of Resin

A poly(n-butyl acrylate-co-methyl methacrylate) random copolymer (Mw=100,000) with a theoretical copolymerization ratio of 80:20 in mass ratio of n-butyl acrylate to methyl methacrylate was obtained in the same manner as in Manufacturing Example 1 of Resin except that 837 parts by mass of n-butyl acrylate and 163 parts by mass of methyl methacrylate (available from Tokyo Chemical Industry Co., Ltd.) were used instead of methyl acrylate, and 2 parts by mass of azobisisobutyronitrile was added.

### Manufacturing Example 10 of Resin

A poly(n-butyl acrylate-r-methyl methacrylate) random copolymer (Mw=180,000) with a theoretical copolymerization ratio of 80:20 in mass ratio of n-butyl acrylate to methyl methacrylate was obtained in the same manner as in Manufacturing Example 1 of Resin except that 837 parts by mass of n-butyl acrylate and 163 parts by mass of methyl methacrylate (available from Tokyo Chemical Industry Co., Ltd.) were used instead of methyl acrylate, and 1 part by mass of azobisisobutyronitrile was added.

### Manufacturing Example 11 of Resin

A total of 2.23 parts by mass of copper(I) bromide (CuBr; available from FUJIFILM Wako Pure Chemical Corporation), 1.04 parts by mass of 2,5-dibromo diethyl adipate (DBADE; available from Tokyo Chemical Industry Co., Ltd.), 85.14 parts by mass of n-butyl acrylate (BA; available from Tokyo Chemical Industry Co., Ltd.), and 15.64 parts by mass of acetonitrile (ACN; available from Tokyo Chemical Industry Co., Ltd.) were charged, and the temperature was raised to 80 degrees Celsius in a nitrogen atmosphere. Next, a solution mixture of 0.35 parts by mass of N,N,N′,N′,N″-pentamethyldiethylenetriamine (PMDETA; available from FUJIFILM Wako Pure Chemical Corporation) and 2.00 parts of ACN was added as an initiator, and the polymerization reaction was carried out until the weight-average molecular weight reached 25,000, as determined by gel permeation chromatography. The reaction solution was filtered through activated alumina to remove the catalyst residue, and then the residual monomer and solvent were removed by drying at 2.6 kPa and 80 degrees Celsius for about 2 hours, yielding a polymer block of poly-butyl acrylate (Mw=25,200).

A total of 50 parts by mass of the polymer block obtained, 1.3 parts by mass of copper(I) bromide, 50 parts by mass of methyl methacrylate, and 20 parts by mass of toluene as a polymerization solvent were mixed, and the temperature was raised to 80 degrees Celsius under stirring in a nitrogen atmosphere. Next, a liquid mixture of 0.1 parts by mass of PMDETA and 2.3 parts of toluene was added as an initiator, and the polymerization reaction was carried out at 80 degrees Celsius until the weight-average molecular weight reached 50,000. The catalyst was removed using the same method as in Manufacturing Example 1 of Resin. The resulting reaction solution was purified through a series of operations: (1) precipitation using a large amount of methanol, (2) dissolution of the precipitate using ethyl acetate, and (3) reprecipitation using methanol. These operations were repeated three times. The precipitate obtained after reprecipitation was filtered and dried, yielding a poly(n-butyl acrylate-b-methyl methacrylate) block copolymer (Mw=50,000) with a theoretical copolymerization ratio of 50:50 in mass ratio of n-butyl acrylate to methyl methacrylate.

### Manufacturing Example 12 of Resin

A mixture of 2.23 parts by mass of copper(I) bromide, 1.04 parts by mass of 2,5-dibromo adipic acid diethyl ester, 102.17 parts by mass of n-butyl acrylate, and 15.64 parts by mass of acetonitrile was prepared. While passing nitrogen gas through this mixture, the temperature was raised to 80 degrees Celsius. Subsequently, a liquid mixture of 0.35 parts by mass of PMDETA and 2.00 parts by mass of ACN was added as an initiator, and the polymerization reaction was carried out until the weight-average molecular weight reached 30,000, as measured by gel permeation chromatography. After the reaction solution was filtered through activated alumina to remove catalyst residues, the remaining monomers and solvents were removed by keeping the solution under 2.6 kPa and 80 degrees Celsius for about 2 hours, yielding a poly-n-butyl acrylate polymer block (Mw=29,800).

Next, 78 parts by mass of the polymer block obtained, 1.3 parts by mass of copper(I) bromide, 35 parts by mass of methyl methacrylate, and 20 parts by mass of toluene as the polymerization solvent were mixed together, and the temperature was raised to 80 degrees Celsius during stirring in a nitrogen stream. A mixed solution of 0.1 parts by mass of PMDETA and 2.3 parts of toluene was then added as an initiator, and the polymerization reaction was carried out at 80 degrees Celsius until the weight-average molecular weight reached 50,000. The catalyst was removed using the same method as in Manufacturing Example 1 of Resin. The resulting reaction solution was purified through a series of operations: (1) precipitation using a large amount of methanol, (2) dissolution of the precipitate using ethyl acetate, and (3) reprecipitation using methanol. These operations were repeated three times. The precipitate obtained after reprecipitation was filtered and dried, yielding a poly(n-butyl acrylate-b-methyl methacrylate) block copolymer (Mw=50,000) with a theoretical copolymerization ratio of 60:40 in mass ratio of n-butyl acrylate to methyl methacrylate.

### Manufacturing Example 13 of Resin

A mixture of 1.39 parts by mass of copper(I) bromide, 0.65 parts by mass of 2,5-dibromo adipic acid diethyl ester, 136.22 parts by mass of n-butyl acrylate, and 15.64 parts by mass of acetonitrile was prepared. While passing nitrogen gas through this mixture, the temperature was raised to 80 degrees Celsius. Subsequently, a liquid mixture of 0.28 parts by mass of PMDETA and 2.00 parts by mass of ACN was added as an initiator, and the polymerization reaction was carried out until the weight-average molecular weight reached 30,000, as measured by gel permeation chromatography. After the reaction solution was filtered through activated alumina to remove catalyst residues, the remaining monomers and solvents were removed by keeping the solution under 2.6 kPa and 80 degrees Celsius for about 2 hours, yielding a poly-n-butyl acrylate polymer block (Mw=29,800).

Next, 104 parts by mass of the polymer block obtained, 1.3 parts by mass of copper(I) bromide, 35 parts by mass of methyl methacrylate, and 20 parts by mass of toluene as the polymerization solvent were mixed together, and the temperature was raised to 80 degrees Celsius during stirring in a nitrogen stream. Next, a mixed solution of 0.1 parts by mass of PMDETA and 2.3 parts by mass of toluene was added as an initiator, and the polymerization reaction was carried out at 80 degrees Celsius until the weight-average molecular weight reached 50,000. The catalyst was removed using the same method as in Manufacturing Example 1 of Resin. The resulting reaction solution was purified through a series of operations: (1) precipitation using a large amount of methanol, (2) dissolution of the precipitate using ethyl acetate, and (3) reprecipitation using methanol. These operations were repeated three times. The precipitate obtained after reprecipitation was filtered and dried, yielding a poly(n-butyl acrylate-b-methyl methacrylate) block copolymer (Mw=50,000) with a theoretical copolymerization ratio of 60:40 in mass ratio of n-butyl acrylate to methyl methacrylate.

### Manufacturing Example 14 of Resin

Into a nitrogen-substituted 200 mL three-neck flask, 92 mL of toluene, 4.5 mL of a 0.7 mol/L toluene solution of isobutylbis(2,6-di-tert-butyl-4-methylphenoxy)aluminum, and 2.4 g of 1,2-dimethoxyethane as a polar additive were added. After stirring until the solution became homogeneous, 0.15 mL of a solution of sec-butyllithium (1.3 mol/L cyclohexane solution) was added as a polymerization initiator.

Next, 2.48 g of methyl methacrylate (MMA) as the first monomer was added at 0 degrees Celsius to conduct polymerization at 0 degrees Celsius. A portion of the solution (2 mL) was taken from the polymerization system as a sample and analyzed by ¹H-NMR, confirming that the conversion rate of MMA was at least 99 percent. The reaction mixture was then poured into 20 mL of methanol to precipitate the polymer, poly(methyl methacrylate) (PMMA), which was collected and dried under reduced pressure. Gel permeation chromatography (GPC) analysis of the polymer dissolved in tetrahydrofuran (THF) revealed that the number-average molecular weight of the polymer was 25,000.

Subsequently, after MMA polymerization, the solution was cooled to −30 degrees Celsius, and 6.30 g of n-butyl acrylate (n-BA) as the second monomer was added over about 30 minutes. After the addition was complete, stirring was continued at −30 degrees Celsius, and a portion of the solution (2 mL) was taken as a sample for analysis by ¹H-NMR, confirming that the conversion rate of n-BA was at least 99 percent. The GPC analysis of the resulting sample in the similar manner revealed that the number-average molecular weight of the polymer was 106,300.

After the polymerization of n-BA, 2.48 g of MMA as the third monomer was added to the solution at −30 degrees Celsius, followed by stirring. After the solution became homogeneous, stirring was continued for 1 hour at −30 degrees Celsius, followed by raising the temperature to 0 degrees Celsius to continue the polymerization reaction. A portion of the solution (2 mL) was taken from the polymerization system and analyzed by ¹H-NMR, confirming that the conversion rate of MMA was 90 percent. Then 10 mL of methanol was added to the polymerization system, and the reaction was allowed to proceed under stirring at room temperature for 1 hour to terminate the polymerization, resulting in deactivation of the active chain ends of the polymer. The entire resulting solution was poured into 2 liters of methanol, and the precipitate obtained was collected. Low-boiling-point substances were removed under reduced pressure, yielding the desired resin.

### Manufacturing Example 15 of Resin

The Manufacturing Example 15 of Resin was obtained in the same manner as in Manufacturing Example 14 of Resin except that the amounts of the first and third monomers (MMA) were changed to 1.98 g each, and the amount of the second monomer (n-BA) was changed to 7.56 g.

### Manufacturing Example 16 of Resin

The Manufacturing Example 16 of Resin was obtained in the same manner as in Manufacturing Example 14 of Resin except that the amounts of the first and third monomers (MMA) were changed to 1.49 g each, and the amount of the second monomer (n-BA) was changed to 8.82 g.

### Manufacturing Example 17 of Resin

The Manufacturing Example 17 of Resin was obtained in the same manner as in Manufacturing Example 14 of Resin except that the amounts of the first and third monomers (MMA) were changed to 1.00 g each, and the amount of the second monomer (n-BA) was changed to 10.08 g.

### Manufacturing Example 18 of Resin

The Manufacturing Example 18 of Resin was obtained in the same manner as in Manufacturing Example 14 of Resin except that the amounts of the first and third monomers (MMA) were changed to 2.30 g each, and the amount of the second monomer (n-BA) was changed to 20.16 g.

### Manufacturing Example 19 of Resin

The Manufacturing Example 19 of Resin was obtained in the same manner as in Manufacturing Example 14 of Resin except that the amounts of the first and third monomers (MMA) were changed to 3.00 g each, and the amount of the second monomer (n-BA) was changed to 26.21 g.

### Manufacturing Example 20 of Resin

The Manufacturing Example 20 of Resin was obtained in the same manner as in Manufacturing Example 14 of Resin except that the amounts of the first and third monomers (MMA) were changed to 4.14 g each, and the amount of the second monomer (n-BA) was changed to 36.29 g.

The materials and resulting products from Manufacturing Example 1 to 20 of Resin are shown in Table 1 in detail. The Mw of poly(methyl methacrylate) listed in Table 1 is the difference between the Mw of the obtained block polymer and the molecular weight of poly(n-butyl acrylate), and is presumed to be the total Mw of the two poly(methyl methacrylate) chains formed at both ends of the poly(n-butyl acrylate).

TABLE 1

| Manufacturing | | Material | | | | |
|---|---|---|---|---|---|---|
| Example of | | Material | Molar | Material | Molar | |
| Resin | Structure | type | ratio | type | ratio | Mw |
| 1 | Single | Methyl | | — | | 50,000 |
| | | acrylate | | | | |
| 2 | | Ethyl | | — | | 50,000 |
| | | acrylate | | | | |
| 3 | | N-butyl | | — | | 50,000 |
| | | acrylate | | | | |
| 4 | | N-butyl | | — | | 18,000 |
| | | acrylate | | | | |
| 5 | | iso-butyl | | — | | 50,000 |
| | | acrylate | | | | |
| 6 | Random | N-butyl | 50 | Methyl | 50 | 50,000 |
| | | acrylate | | methacrylate | | |
| 7 | | N-butyl | 60 | Methyl | 40 | 50,000 |
| | | acrylate | | methacrylate | | |
| 8 | | N-butyl | 80 | Methyl | 20 | 50,000 |
| | | acrylate | | methacrylate | | |
| 9 | | N-butyl | 80 | Methyl | 20 | 100,000 |
| | | acrylate | | methacrylate | | |
| 10 | | N-butyl | 80 | Methyl | 20 | 180,000 |
| | | acrylate | | methacrylate | | |
| 11 | Diblock | N-butyl | 50 | Methyl | 50 | 50000 |
| | | acrylate | | methacrylate | | |
| 12 | | N-butyl | 60 | Methyl | 40 | 50,000 |
| | | acrylate | | methacrylate | | |
| 13 | | N-butyl | 80 | Methyl | 20 | 50000 |
| | | acrylate | | methacrylate | | |
| 14 | Triblock | N-butyl | 50 | Methyl | 50 | 50,000 |
| | | acrylate | | methacrylate | | |
| 15 | | N-butyl | 60 | Methyl | 40 | 50,000 |
| | | acrylate | | methacrylate | | |
| 16 | | N-butyl | 70 | Methyl | 30 | 50,000 |
| | | acrylate | | methacrylate | | |
| 17 | | N-butyl | 80 | Methyl | 20 | 50,000 |
| | | acrylate | | methacrylate | | |
| 18 | | N-butyl | 80 | Methyl | 20 | 100,000 |
| | | acrylate | | methacrylate | | |
| 19 | | N-butyl | 80 | Methyl | 20 | 130,000 |
| | | acrylate | | methacrylate | | |
| 20 | | N-butyl | 80 | Methyl | 20 | 180,000 |
| | | acrylate | | methacrylate | | |

### Examples 1 to 134 to Comparative Examples 1 to 8

### Formation of Insulating Resin Layer

### Preparation of Liquid Composition

As shown in Tables 2 to 5, a mixture of polymerizable compounds and solvents was prepared to form Liquid Mixture 1. Subsequently, as shown in Tables 6 to 8, Liquid Composition 1 was prepared by mixing Liquid Mixture 1, the resin obtained in Manufacturing Example 20 of Resin, and a photopolymerization initiator (1-Benzoylcyclohexanol, available from Tokyo Chemical Industry Co., Ltd.). The amount of photopolymerization initiator added was 1 percent by mass to the entire of the polymerizable compound.

The liquid compositions of Examples 2 to 134 and Comparative Examples 1 to 8 were prepared in the same manner as Example 1, except for the changes in the compositions listed in Tables 2 to 8.

TABLE 2

| | Insoluble | | | | |
|---|---|---|---|---|---|
| | polymerizable | | Soluble | | |
| | compound | | polymerizable | | |
| | | Mass ratio | compound | | Solvent |
| Liquid | | (mixing | | Mass | soluble |
| mixture | Type | ratio Y) | Type | ratio | point |
| 1 | PEG200DA | 1 | — | — | — |
| 2 | PEG200DA | 1 | — | — | — |
| 3 | PEG200DA | 1 | — | — | — |
| 4 | PEG200DA | 1 | — | — | — |
| 5 | PEG200DA | 1 | — | — | — |
| 6 | PEG200DA | 1 | — | — | — |
| 7 | PEG200DA | 0.22 | APG-200 | 0.78 | 2 |
| 8 | PEG200DA | 0.12 | APG-200 | 0.88 | 2 |
| 9 | PEG200DA | 0.02 | APG-200 | 0.98 | 2 |
| 10 | PEG200DA | 0.30 | APG-400 | 0.70 | 10 |
| 11 | PEG200DA | 0.20 | APG-400 | 0.80 | 10 |
| 12 | PEG200DA | 0.10 | APG-400 | 0.90 | 10 |
| 13 | PEG200DA | 0.13 | 1,4- | 0.87 | 13 |
| | | | Bis(acryloyloxy)butane | | |
| 14 | PEG200DA | 0.27 | 1,6- | 0.73 | 27 |
| | | | Bis(acryloyloxy)hexane | | |
| 15 | PEG200DA | 0.40 | 1,9- | 0.60 | 40 |
| | | | Bis(acryloyloxy)nonane | | |
| 16 | PEG200DA | 0.33 | Neopentyl glycol | 0.67 | 33 |
| | | | diacrylate | | |
| 17 | PEG200DA | 0.30 | Light Acrylate MPD-A | 0.70 | 30 |
| 18 | PEG200DA | 0.38 | MIRAMER M216 | 0.62 | 38 |
| 19 | PEG200DA | 0.23 | HPP-A | 0.77 | 23 |
| 20 | PEG200DA | 0.17 | M-310 | 0.83 | 17 |
| 21 | PEG200DA | 0.25 | M-321 | 0.75 | 25 |
| 22 | A-400 | 1 | — | — | — |
| 23 | A-400 | 0.15 | APG-200 | 0.85 | 15 |
| 24 | A-400 | 0.17 | APG-200 | 0.83 | 15 |
| 25 | #230D | 1 | — | — | — |
| 26 | #230D | 1 | — | — | — |
| 27 | #230D | 1 | — | — | — |
| 28 | #230D | 1 | — | — | — |
| 29 | #230D | 1 | — | — | — |
| 30 | #230D | 1 | — | — | — |

| | | | Good solvent | | | |
|---|---|---|---|---|---|---|
| | Poor solvent | | | Mass ratio | Polymerizable | |
| Liquid | | Mass | | (mixing | compound | Solid |
| mixture | Type | ratio | Type | ratio X) | soluble point | portion |
| 1 | Menthane | 0.48 | Diethylene | 0.52 | 52 | 0.50 |
| | | | glycol diethyl | | | |
| | | | ether | | | |
| 2 | Menthane | 0.43 | Diethylene | 0.57 | 52 | 0.50 |
| | | | glycol diethyl | | | |
| | | | ether | | | |
| 3 | Menthane | 0.38 | Diethylene | 0.62 | 52 | 0.50 |
| | | | glycol diethyl | | | |
| | | | ether | | | |
| 4 | Menthane | 0.45 | Diethylene | 0.55 | 52 | 0.50 |
| | | | glycol diethyl | | | |
| | | | ether | | | |
| 5 | Menthane | 0.45 | Ethyl octane | 0.55 | 55 | 0.50 |
| 6 | Decane | 0.24 | Diethylene | 0.76 | 76 | 0.50 |
| | | | glycol diethyl | | | |
| | | | ether | | | |
| 7 | Menthane | 1.00 | — | — | — | 0.50 |
| 8 | Menthane | 1.00 | — | — | — | 0.50 |
| 9 | Menthane | 1.00 | — | — | — | 0.50 |
| 10 | Menthane | 1.00 | — | — | — | 0.50 |
| 11 | Menthane | 1.00 | — | — | — | 0.50 |
| 12 | Menthane | 1.00 | — | — | — | 0.50 |
| 13 | Menthane | 1.00 | — | — | — | 0.50 |
| 14 | Menthane | 1.00 | — | — | — | 0.50 |
| 15 | Menthane | 1.00 | — | — | — | 0.50 |
| 16 | Menthane | 1.00 | — | — | — | 0.50 |
| 17 | Menthane | 1.00 | — | — | — | 0.50 |
| 18 | Menthane | 1.00 | — | — | — | 0.50 |
| 19 | Menthane | 1.00 | — | — | — | 0.50 |
| 20 | Menthane | 1 | — | — | — | 0.50 |
| 21 | Menthane | 1 | — | — | — | 0.50 |
| 22 | Menthane | 0.35 | Diethylene | 0.65 | 65 | 0.50 |
| | | | glycol diethyl | | | |
| | | | ether | | | |
| 23 | Menthane | 1.00 | — | — | — | 0.50 |
| 24 | Menthane | 1.00 | — | — | — | 0.50 |
| 25 | Menthane | 0.28 | Diethylene | 0.72 | 72 | 0.50 |
| | | | glycol diethyl | | | |
| | | | ether | | | |
| 26 | Menthane | 0.23 | Diethylene | 0.77 | 72 | 0.50 |
| | | | glycol diethyl | | | |
| | | | ether | | | |
| 27 | Menthane | 0.18 | Diethylene | 0.82 | 72 | 0.50 |
| | | | glycol diethyl | | | |
| | | | ether | | | |
| 28 | Decane | 0.57 | 2-Ethylhexyl | 0.43 | 43 | 0.50 |
| | | | Acetate | | | |
| 29 | Menthane | 0.53 | Mesitylene | 0.47 | 47 | 0.50 |
| 30 | Decane | 0.70 | Mesitylene | 0.30 | 30 | 0.50 |

TABLE 3

| | Insoluble | | | | |
|---|---|---|---|---|---|
| | polymerizable | | Soluble | | |
| | compound | | polymerizable | | |
| | | Mass ratio | compound | | Solvent |
| Liquid | | (mixing | | Mass | soluble |
| mixture | Type | ratio Y) | Type | ratio | point |
| 31 | #230D | 1 | — | — | — |
| 32 | #230D | 1 | — | — | — |
| 33 | #230D | 1 | — | — | — |
| 34 | #230D | 0.25 | HPP-A | 0.75 | 25 |
| 35 | #230D | 0.5 | HPP-A | 0.5 | 50 |
| 36 | #230D | 0.75 | HPP-A | 0.25 | 75 |
| 37 | #230D | 0.45 | HPP-A | 0.55 | 45 |
| 38 | #230D | 0.05 | HPP-A | 0.95 | 5 |
| 39 | #230D | 0.25 | HPP-A | 0.75 | 25 |
| 40 | #230D | 0.5 | HPP-A | 0.5 | 50 |
| 41 | #230D | 0.75 | HPP-A | 0.25 | 75 |
| 42 | #230D | 0.45 | MIRAMER | 0.55 | 45 |
| | | | M210 | | |
| 43 | #230D | 0.35 | APG-200 | 0.65 | 35 |
| 44 | #230D | 0.48 | APG-400 | 0.52 | 48 |
| 45 | #230D | 1 | — | — | — |
| 46 | #230D | 1 | — | — | — |
| 47 | #230D | 0.25 | HPP-A | 0.75 | 25 |
| 48 | #230D | 0.5 | HPP-A | 0.5 | 50 |
| 49 | #230D | 0.75 | HPP-A | 0.25 | 75 |
| 50 | HX220 | 1 | — | — | — |
| 51 | HX220 | 1 | — | — | — |
| 52 | HX220 | 0.55 | HPP-A | 0.45 | 55 |
| 53 | HX220 | 0.55 | MIRAMER | 0.45 | 55 |
| | | | M210 | | |
| 54 | HX220 | 0.1 | HPP-A | 0.9 | 10 |
| 55 | HX220 | 0.52 | APG-200 | 0.48 | 52 |
| 56 | HX220 | 0.68 | APG-400 | 0.32 | 68 |
| 57 | HX220 | 0.57 | M321 | 0.43 | 57 |
| 58 | HX220 | 0.55 | ADTMP | 0.45 | 55 |
| 59 | HX620 | 0.38 | HPP-A | 0.62 | 38 |
| 60 | HX620 | 0.38 | MIRAMER | 0.62 | 38 |
| | | | M210 | | |

| | | | Good solvent | | | |
|---|---|---|---|---|---|---|
| | Poor solvent | | | Mass ratio | Polymerizable | |
| Liquid | | Mass | | (mixing | compound | Solid |
| mixture | Type | ratio | Type | ratio X) | soluble point | portion |
| 31 | EXXSOL | 0.60 | 2-Ethylhexyl | 0.40 | 40 | 0.50 |
| | D40 | | Acetate | | | |
| 32 | IsoperH | 0.60 | 2-Ethylhexyl | 0.40 | 40 | 0.50 |
| | | | Acetate | | | |
| 33 | IsoperI | 0.67 | 2-Ethylhexyl | 0.33 | 33 | 0.50 |
| | | | Acetate | | | |
| 34 | Decane | 0.87 | Mesitylene | 0.13 | 13 | 0.50 |
| 35 | Decane | 0.75 | Mesitylene | 0.25 | 15 | 0.50 |
| 36 | Decane | 0.65 | Mesitylene | 0.35 | 15 | 0.50 |
| 37 | Menthane | 1.00 | — | — | — | 0.50 |
| 38 | Decane | 1.00 | — | — | — | 0.50 |
| 39 | Decane | 0.90 | 2-Ethylhexyl | 0.10 | 10 | 0.50 |
| | | | Acetate | | | |
| 40 | Decane | 0.77 | 2-Ethylhexyl | 0.23 | 13 | 0.50 |
| | | | Acetate | | | |
| 41 | Decane | 0.67 | 2-Ethylhexyl | 0.33 | 13 | 0.50 |
| | | | Acetate | | | |
| 42 | Menthane | 1.00 | — | — | — | 0.50 |
| 43 | Menthane | 1.00 | — | — | — | 0.50 |
| 44 | Menthane | 1.00 | — | — | — | 0.50 |
| 45 | Menthane | 0.50 | p-cymene | 0.50 | 50 | 0.50 |
| 46 | Decane | 0.70 | p-cymene | 0.30 | 30 | 0.50 |
| 47 | Decane | 0.87 | p-cymene | 0.13 | 13 | 0.50 |
| 48 | Decane | 0.75 | p-cymene | 0.25 | 25 | 0.50 |
| 49 | Decane | 0.62 | p-cymene | 0.38 | 38 | 0.50 |
| 50 | Menthane | 0.53 | Diethylene glycol | 0.47 | 47 | 0.50 |
| | | | diethyl ether | | | |
| 51 | Decane | 0.75 | Tetrahydrolinalool | 0.25 | 25 | 0.50 |
| 52 | Menthane | 1 | — | — | — | 0.50 |
| 53 | Menthane | 1 | — | — | — | 0.50 |
| 54 | Decane | 1 | — | — | — | 0.50 |
| 55 | Menthane | 1 | — | — | — | 0.50 |
| 56 | Menthane | 1 | — | — | — | 0.50 |
| 57 | Menthane | 1 | — | — | — | 0.50 |
| 58 | Menthane | 1 | — | — | — | 0.50 |
| 59 | Menthane | 1 | — | — | — | 0.50 |
| 60 | Menthane | 1 | — | — | — | 0.50 |

TABLE 4

| | Insoluble | | | | |
|---|---|---|---|---|---|
| | polymerizable | | | | |
| | compound | | | | |
| | | Mass | Soluble polymerizable | | |
| | | ratio | compound | | Solvent |
| Liquid | | (mixing | | Mass | soluble |
| mixture | Type | ratio Y) | Type | ratio | point |
| 61 | HX620 | 0.67 | M321 | 0.33 | 67 |
| 62 | 9G | 0.25 | APG-200 | 0.75 | 25 |
| 63 | 14G | 0.17 | APG-200 | 0.83 | 17 |
| 64 | 9G | 0.33 | APG-400 | 0.67 | 33 |
| 65 | 14G | 0.22 | APG-400 | 0.78 | 22 |
| 66 | 14G | 0.13 | HPP-A | 0.87 | 13 |
| 67 | 14G | 0.25 | MIRAMER | 0.75 | 25 |
| | | | M216 | | |
| 68 | 14G | 0.25 | Light Acrylate | 0.75 | 25 |
| | | | MPD-A | | |
| 69 | 14G | 0.28 | A-NPG | 0.72 | 28 |
| 70 | 14G | 0.1 | 1,4-Bis(acryl- | 0.9 | 10 |
| | | | oyloxy)butane | | |
| 71 | 14G | 0.2 | 1,6-Bis(acryl- | 0.8 | 20 |
| | | | oyloxy)hexane | | |
| 72 | 14G | 0.3 | 1,9-Bis(acryl- | 0.7 | 30 |
| | | | oyloxy)nonane | | |
| 73 | CN2283NS | 1 | — | — | — |
| 74 | CN2283NS | 0.9 | HPP-A | 0.1 | 90 |
| 75 | CN2283NS | 0.75 | HPP-A | 0.25 | 75 |
| 76 | CN2283NS | 0.5 | HPP-A | 0.5 | 50 |
| 77 | CN2283NS | 0.25 | HPP-A | 0.75 | 25 |
| 78 | CN2283NS | 0.1 | HPP-A | 0.9 | 10 |
| 79 | CN2283NS | 0.35 | HPP-A | 0.35 | 50 |
| 80 | CN2283NS | 0.4 | HPP-A | 0.4 | 50 |
| 81 | CN2283NS | 0.6 | HPP-A | 0.6 | 50 |
| 82 | CN2283NS | 0.7 | HPP-A | 0.7 | 50 |
| 83 | CN2273NS | 1 | — | — | — |
| 84 | M6100 | 1 | — | — | — |
| 85 | M6500 | 1 | — | — | — |
| 86 | CN2283NS | 0.35 | CN2270NS | 0.65 | 35 |
| 87 | CN2273NS | 0.87 | CN2270NS | 0.13 | 87 |
| 88 | M6100 | 0.01 | CN2270NS | 0.99 | 1 |
| 89 | M6500 | 0.02 | CN2270NS | 0.98 | 2 |
| 90 | #230D | 0.3 | CN2270NS | 0.7 | 30 |
| 91 | HX220 | 0.37 | CN2270NS | 0.63 | 37 |
| 92 | HX620 | 0.17 | CN2270NS | 0.83 | 17 |

| | | | Good solvent | | Polymer- | |
|---|---|---|---|---|---|---|
| | | | | Mass | izable | |
| | Poor solvent | | | ratio | compound | |
| Liquid | | Mass | | (mixing | soluble | Solid |
| mixture | Type | ratio | Type | ratio X) | point | portion |
| 61 | Menthane | 1 | — | — | — | 0.50 |
| 62 | Menthane | 1 | — | — | — | 0.50 |
| 63 | Menthane | 1 | — | — | — | 0.50 |
| 64 | Menthane | 1 | — | — | — | 0.50 |
| 65 | Menthane | 1 | — | — | — | 0.50 |
| 66 | Menthane | 1 | — | — | — | 0.50 |
| 67 | Menthane | 1 | — | — | — | 0.50 |
| 68 | Menthane | 1 | — | — | — | 0.50 |
| 69 | Menthane | 1 | — | — | — | 0.50 |
| 70 | Menthane | 1 | — | — | — | 0.50 |
| 71 | Menthane | 1 | — | — | — | 0.50 |
| 72 | Menthane | 1 | — | — | — | 0.50 |
| 73 | Decane | 0.62 | 2-Ethylhexyl | 0.38 | 38 | 0.50 |
| | | | acetate | | | |
| 74 | Decane | 0.65 | 2-Ethylhexyl | 0.35 | 35 | 0.50 |
| | | | acetate | | | |
| 75 | Decane | 0.7 | 2-Ethylhexyl | 0.3 | 30 | 0.50 |
| | | | acetate | | | |
| 76 | Decane | 0.77 | 2-Ethylhexyl | 0.23 | 23 | 0.50 |
| | | | acetate | | | |
| 77 | Decane | 0.87 | 2-Ethylhexyl | 0.13 | 13 | 0.50 |
| | | | acetate | | | |
| 78 | Decane | 0.97 | 2-Ethylhexyl | 0.03 | 3 | 0.50 |
| | | | acetate | | | |
| 79 | Decane | 0.77 | 2-Ethylhexyl | 0.23 | 23 | 0.41 |
| | | | acetate | | | |
| 80 | Decane | 0.77 | 2-Ethylhexyl | 0.23 | 23 | 0.44 |
| | | | acetate | | | |
| 81 | Decane | 0.77 | 2-Ethylhexyl | 0.23 | 23 | 0.55 |
| | | | acetate | | | |
| 82 | Decane | 0.77 | 2-Ethylhexyl | 0.23 | 23 | 0.58 |
| | | | acetate | | | |
| 83 | Decane | 0.95 | 2-Ethylhexyl | 0.05 | 5 | 0.50 |
| | | | acetate | | | |
| 84 | Decane | 0.02 | 2-Ethylhexyl | 0.98 | 98 | 0.50 |
| | | | acetate | | | |
| 85 | Decane | 0.30 | 2-Ethylhexyl | 0.70 | 70 | 0.50 |
| | | | acetate | | | |
| 86 | Decane | 1.00 | — | — | — | — |
| 87 | Decane | 1.00 | — | — | — | — |
| 88 | Decane | 1.00 | — | — | — | — |
| 89 | Decane | 1.00 | — | — | — | — |
| 90 | Decane | 1.00 | — | — | — | — |
| 91 | Decane | 1.00 | — | — | — | — |
| 92 | Decane | 1.00 | — | — | — | — |

TABLE 5

| | Insoluble | | | | |
|---|---|---|---|---|---|
| | polymerizable | | Soluble | | |
| | compound | | polymerizable | | |
| | | Mass ratio | compound | | Solvent |
| Liquid | | (mixing | | Mass | soluble |
| mixture | Type | ratio Y) | Type | ratio | point |
| 93 | PEG200DA | 1 | — | — | — |
| 94 | PEG200DA | 0.24 | APG-200 | 0.76 | 2 |
| 95 | PEG200DA | 0.08 | APG-400 | 0.92 | 10 |
| 96 | PEG200DA | 0.32 | APG-400 | 0.68 | 10 |
| 97 | PEG200DA | 1 | — | — | — |
| 98 | PEG200DA | 1 | — | — | — |

| | | | Good solvent | | | |
|---|---|---|---|---|---|---|
| | Poor solvent | | | Mass ratio | Polymerizable | |
| Liquid | | Mass | | (mixing | compound | Solid |
| mixture | Type | ratio | Type | ratio X) | soluble point | portion |
| 93 | Menthane | 0.50 | Diethylene | 0.50 | 64 | 0.50 |
| | | | glycol diethyl | | | |
| | | | ether | | | |
| 94 | Menthane | 1.00 | — | — | — | 0.50 |
| 95 | Menthane | 1.00 | — | — | — | 0.50 |
| 96 | Menthane | 1.00 | — | — | — | 0.50 |
| 97 | — | — | — | — | — | — |
| 98 | Menthane | 0.39 | Diethylene | 0.61 | 50 | 0.50 |
| | | | glycol diethyl | | | |
| | | | ether | | | |

TABLE 6

| | Liquid | | | | |
|---|---|---|---|---|---|
| | mixture | | Resin | | Evaluation results |
| | | Mass | Manufacturing | Mass | Curl development |
| Example | No. | ratio | Example No. | ratio | reduction effect |
| 1 | 1 | 200 | 20 | 2 | A |
| 2 | 2 | 200 | 20 | 2 | A |
| 3 | 3 | 200 | 20 | 2 | B |
| 4 | 4 | 200 | 20 | 2 | A |
| 5 | 5 | 200 | 20 | 2 | A |
| 6 | 6 | 200 | 20 | 2 | A |
| 7 | 7 | 200 | 20 | 2 | A |
| 8 | 8 | 200 | 20 | 2 | A |
| 9 | 9 | 200 | 20 | 2 | B |
| 10 | 10 | 200 | 20 | 2 | A |
| 11 | 11 | 200 | 20 | 2 | A |
| 12 | 12 | 200 | 20 | 2 | B |
| 13 | 13 | 200 | 20 | 2 | A |
| 14 | 14 | 200 | 20 | 2 | A |
| 15 | 15 | 200 | 20 | 2 | A |
| 16 | 16 | 200 | 20 | 2 | A |
| 17 | 17 | 200 | 20 | 2 | A |
| 18 | 18 | 200 | 20 | 2 | A |
| 19 | 19 | 200 | 20 | 2 | A |
| 20 | 20 | 200 | 20 | 2 | A |
| 21 | 21 | 200 | 20 | 2 | A |
| 22 | 22 | 200 | 20 | 2 | A |
| 23 | 23 | 200 | 20 | 2 | A |
| 24 | 24 | 200 | 20 | 2 | A |
| 25 | 25 | 200 | 20 | 2 | A |
| 26 | 26 | 200 | 20 | 2 | A |
| 27 | 27 | 200 | 20 | 2 | A |
| 28 | 28 | 200 | 20 | 2 | A |
| 29 | 29 | 200 | 20 | 2 | A |
| 30 | 30 | 200 | 20 | 2 | A |
| 31 | 31 | 200 | 20 | 2 | A |
| 32 | 32 | 200 | 20 | 2 | A |
| 33 | 33 | 200 | 20 | 2 | A |
| 34 | 34 | 200 | 20 | 2 | A |
| 35 | 35 | 200 | 20 | 2 | A |
| 36 | 36 | 200 | 20 | 2 | B |
| 37 | 37 | 200 | 20 | 2 | A |
| 38 | 38 | 200 | 20 | 2 | A |
| 39 | 39 | 200 | 20 | 2 | A |
| 40 | 40 | 200 | 20 | 2 | A |
| 41 | 41 | 200 | 20 | 2 | B |
| 42 | 42 | 200 | 20 | 2 | A |
| 43 | 43 | 200 | 20 | 2 | A |
| 44 | 44 | 200 | 20 | 2 | A |
| 45 | 45 | 200 | 20 | 2 | A |
| 46 | 46 | 200 | 20 | 2 | A |
| 47 | 47 | 200 | 20 | 2 | A |
| 48 | 48 | 200 | 20 | 2 | A |
| 49 | 49 | 200 | 20 | 2 | A |
| 50 | 50 | 200 | 20 | 2 | A |
| 51 | 51 | 200 | 20 | 2 | A |
| 52 | 52 | 200 | 20 | 2 | A |
| 53 | 53 | 200 | 20 | 2 | A |
| 54 | 54 | 200 | 20 | 2 | A |
| 55 | 55 | 200 | 20 | 2 | A |
| 56 | 56 | 200 | 20 | 2 | A |
| 57 | 57 | 200 | 20 | 2 | A |
| 58 | 58 | 200 | 20 | 2 | A |
| 59 | 59 | 200 | 20 | 2 | A |
| 60 | 60 | 200 | 20 | 2 | A |

TABLE 7

| | Liquid | | | | |
|---|---|---|---|---|---|
| | mixture | | Resin | | Evaluation results |
| | | Mass | Manufacturing | Mass | Curl development |
| Example | No. | ratio | Example No. | ratio | reduction effect |
| 61 | 61 | 200 | 20 | 2 | A |
| 62 | 62 | 200 | 20 | 2 | A |
| 63 | 63 | 200 | 20 | 2 | A |
| 64 | 64 | 200 | 20 | 2 | A |
| 65 | 65 | 200 | 20 | 2 | A |
| 66 | 66 | 200 | 20 | 2 | A |
| 67 | 67 | 200 | 20 | 2 | A |
| 68 | 68 | 200 | 20 | 2 | A |
| 69 | 69 | 200 | 20 | 2 | A |
| 70 | 70 | 200 | 20 | 2 | A |
| 71 | 71 | 200 | 20 | 2 | A |
| 72 | 72 | 200 | 20 | 2 | A |
| 73 | 73 | 200 | 20 | 2 | A |
| 74 | 74 | 200 | 20 | 2 | A |
| 75 | 75 | 200 | 20 | 2 | A |
| 76 | 76 | 200 | 20 | 2 | A |
| 77 | 76 | 200 | 1 | 2 | B |
| 78 | 76 | 200 | 2 | 2 | B |
| 79 | 76 | 200 | 3 | 2 | B |
| 80 | 76 | 200 | 4 | 2 | B |
| 81 | 76 | 200 | 5 | 2 | B |
| 82 | 76 | 200 | LOTRYL35BA40 | 2 | B |
| 83 | 76 | 200 | 6 | 2 | B |
| 84 | 76 | 200 | 7 | 2 | B |
| 85 | 76 | 200 | 8 | 2 | B |
| 86 | 76 | 200 | 9 | 2 | B |
| 87 | 76 | 200 | 10 | 2 | B |
| 88 | 76 | 200 | 11 | 2 | B |
| 89 | 76 | 200 | 12 | 2 | A |
| 90 | 76 | 200 | 13 | 2 | A |
| 91 | 76 | 200 | 14 | 2 | A |
| 92 | 76 | 200 | 15 | 2 | A |
| 93 | 76 | 200 | 16 | 2 | A |
| 94 | 76 | 200 | 17 | 2 | A |
| 95 | 76 | 200 | 18 | 2 | A |
| 96 | 76 | 200 | 19 | 2 | A |
| 97 | 77 | 200 | 20 | 2 | A |
| 98 | 78 | 200 | 20 | 2 | A |
| 99 | 76 | 200 | 20 | 4 | A |
| 100 | 76 | 200 | 20 | 6 | A |
| 101 | 40 | 200 | 1 | 2 | B |
| 102 | 40 | 200 | 2 | 2 | B |
| 103 | 40 | 200 | 3 | 2 | B |
| 104 | 40 | 200 | 4 | 2 | B |
| 105 | 40 | 200 | 5 | 2 | B |
| 106 | 40 | 200 | 6 | 2 | B |
| 107 | 40 | 200 | 7 | 2 | B |
| 108 | 40 | 200 | 8 | 2 | B |
| 109 | 40 | 200 | 9 | 2 | B |
| 110 | 40 | 200 | 10 | 2 | B |
| 111 | 40 | 200 | 11 | 2 | B |
| 112 | 40 | 200 | 12 | 2 | A |
| 113 | 40 | 200 | 13 | 2 | A |
| 114 | 40 | 200 | 14 | 2 | A |
| 115 | 40 | 200 | 15 | 2 | A |
| 116 | 40 | 200 | 16 | 2 | A |
| 117 | 40 | 200 | 17 | 2 | A |
| 118 | 40 | 200 | 18 | 2 | A |
| 119 | 40 | 200 | 19 | 2 | A |
| 120 | 40 | 200 | 20 | 2 | A |
| 121 | 79 | 200 | 20 | 2 | A |
| 122 | 80 | 200 | 20 | 2 | A |
| 123 | 81 | 200 | 20 | 2 | A |
| 124 | 82 | 200 | 20 | 2 | B |
| 125 | 83 | 200 | 20 | 2 | B |
| 126 | 84 | 200 | 20 | 2 | B |
| 127 | 85 | 200 | 20 | 2 | B |
| 128 | 86 | 200 | 20 | 2 | B |
| 129 | 87 | 200 | 20 | 2 | B |
| 130 | 88 | 200 | 20 | 2 | B |
| 131 | 89 | 200 | 20 | 2 | B |
| 132 | 90 | 200 | 20 | 2 | B |
| 133 | 91 | 200 | 20 | 2 | B |
| 134 | 92 | 200 | 20 | 2 | B |

TABLE 8

| | Liquid | | | | |
|---|---|---|---|---|---|
| | mixture | | Resin | | Evaluation results |
| Comparative | | Mass | Manufacturing | Mass | Curl development |
| Example | No. | ratio | Example No. | ratio | reduction effect |
| 1 | 1 | 200 | Methyl | 2 | C |
| | | | methacrylate | | |
| 2 | 1 | 200 | Polyvinyl | 2 | C |
| | | | pyrrolidone | | |
| 3 | 93 | 200 | 20 | 2 | Two liquid |
| | | | | | separation |
| | | | | | (no ink formed) |
| 4 | 94 | 200 | 20 | 2 | Two liquid |
| | | | | | separation |
| | | | | | (no ink formed) |
| 5 | 95 | 200 | 20 | 2 | C |
| 6 | 96 | 200 | 20 | 2 | Two liquid |
| | | | | | separation |
| | | | | | (no ink formed) |
| 7 | 97 | 100 | 21 | 2 | C |
| 8 | 98 | 200 | 20 | 2 | C |

The details of each material shown in Tables 2 to 8 are as follows.
PEG200DA (PEG200 diacrylate, available from Daicel Ornitech Co., Ltd.)
A-200 (Polyethylene glycol #200 diacrylate, available from Shin-Nakamura Chemical Co., Ltd.
A-400 (Polyethylene glycol #400 diacrylate, available from Shin-Nakamura Chemical Co., Ltd.
VISCOAT® #230D (1,6-Hexanediol acrylic acid polymer ester, available from Osaka Organic Chemical Industry Ltd.)
KAYARAD HX220 (6-(Propionyloxy)hexanoic acid 3-[2,2-Dimethyl-3-[[(1-Oxo-6-(propionyloxy)hexyl]oxy]propoxy]-2,2-dimethyl-3-oxopropyl, available from Nippon Kayaku Co., Ltd.)
KAYARAD HX620 (Poly [oxy(1-oxo-1,6-hexanediyl)], α-hydro-ω-[(1-oxo-2-propenyl)oxy]-3-hydroxy-2,2-dimethylpropyl 3-hydroxy-2,2-dimethylpropanoate (9CI) diester, available from Nippon Kayaku Co., Ltd.)
9G (Polyethylene glycol #400 dimethacrylate, available from Shin-Nakamura Chemical Co., Ltd.
14G (Polyethylene glycol #600 dimethacrylate, available from Shin-Nakamura Chemical Co., Ltd.
CN2207NS (Polyester acrylate, available from Sartomer Company, Inc.)
CN2273NS (Polyester acrylate, available from Sartomer Company, Inc.)
CN2283NS (Polyester acrylate, available from Sartomer Company, Inc.)
M6100 (Polyester acrylate, available from TOAGOSEI CO., LTD.)
M6500 (Polyester acrylate, available from TOAGOSEI CO., LTD.)
APG-200 (tripropylene glycol diacrylate, available from Shin-Nakamura Chemical Co., Ltd.)
APG-400 (tripropylene glycol diacrylate #400, available from Shin-Nakamura Chemical Co., Ltd.)
MIRAMER M216 (Phenol EO-modified acrylate, available from Toyo Chemicals Co., Ltd.)
Light Acrylate HPP-A (Neopentyl glycol hydroxypivalate acrylate adduct, available from Kyoeisha Chemical Co., Ltd.)
M-310 (PO-modified trimethylol propane triacrylate, available from TOAGOSEI CO., LTD.)
M-321 (PO-modified trimethylol propane triacrylate, available from TOAGOSEI CO., LTD.)
ADTMP (ditriimethylol propane triacrylate (available from Shin-Nakamura Chemical Co., Ltd.)
A-NPG (Neopentyl glycol diacrylate, available from Shin-Nakamura Chemical Co., Ltd.)
LOTRYL 35BA40 (Ethylene-Acrylate-n-butyl) random copolymer, available from Arkema)

### Formation of Insulating Resin Layer

Each of the liquid compositions was applied onto an aluminum foil (5 cm×5 cm, thickness: 20 km) using a bar coater and then cured by ultraviolet irradiation (light source: UV-LED, product name: FJ800, available from Phoseon Technology), wavelength: 365 nm, irradiation intensity: 30 mW/cm², irradiation time: 20 s) directed at the coated area. Next, the cured product was heated using a hot plate at 120 degrees Celsius for 1 minute to remove the solvent, followed by additional drying at 120 degrees Celsius for 10 minutes to obtain each insulating resin layer, with an average thickness of 100 km.

### Evaluation Criteria on Curl Development Reduction Effect

The maximum distance (maximum warping height) between the horizontal surface and the lower surface of each of the insulating resin layer, as observed from the horizontal direction, was measured. The lower surface of the insulating resin layer refers to the surface opposite to the side facing the horizontal plane. Based on the measured maximum warping height, the curl development reduction effect was evaluated. The number of measurement samples was three, and the average value of these samples was used as the measurement result. It should be noted that a rating of B or above indicates that there are no issues in practical use. The results are shown in Tables 6 to 8.

### Evaluation Criteria for Curl Development Reduction Effect

A: Maximum warping height is at most 3 mm
B: Maximum warping height exceeds 3 mm but is less than 5 mm
C: Maximum warping height is at least 5 mm

As seen in the results of Examples, it is clear that the insulating resin layer formed by the liquid composition of the present disclosure exhibits excellent effects on reducing curl development due to volume shrinkage.

In Comparative Examples 1 and 2, the non-crosslinked resin contained in the liquid composition did not have the structure represented by Chemical Formula 3, and since a porous structure was not formed in the insulating resin layer, which is a cured product of the liquid composition, the residual stress caused by volume shrinkage could not be dispersed, resulting in curl development in the insulating resin layer.

In Comparative Example 3, since the liquid composition 93 did not satisfy Relationship 1, phase separation occurred in the liquid composition after the materials were mixed, making it impossible to form an insulating resin layer.

In Comparative Examples 4 to 6, since the liquid compositions 94 to 96 did not satisfy Relationship 2, phase separation occurred in the liquid composition after the materials were mixed, making it impossible to form an insulating resin layer, or a porous structure was not formed in the insulating resin layer, which is a cured product of the liquid composition, and the residual stress due to volume shrinkage could not be dispersed, resulting in curl in the insulating resin layer.

In Comparative Example 7, since the liquid composition 97 did not satisfy Relationships 1 and 2, a porous structure was not formed in the insulating resin layer, which is a cured product of the liquid composition, and the residual stress caused by volume shrinkage could not be dispersed, resulting in curl in the insulating resin layer.

In Comparative Example 8, since the liquid composition 98 did not satisfy Relationship 1, a porous structure was not formed in the insulating resin layer, which is a cured product of the liquid composition, and the residual stress caused by volume shrinkage could not be dispersed, resulting in curl in the insulating resin layer.

### Example 135

### Fabrication of Solid State Battery

### Preparation of Active Material

Nickel-based active material (NCM, available from TOSHIMA Manufacturing Co., Ltd.) was used as the positive electrode active material. LiNbO₃ was used as the ion-conductive oxide for surface coating the NCM particles. The LiNbO₃ coating layer was formed by hydrolyzing an alkoxide solution containing lithium and niobium on the surface of NCM powder particles, based on J. Mater. Chem. A. 2021, 9, 4117-4125. One specific method is as follows.

First, an ethanol solution of lithium ethoxide was prepared by dissolving metallic lithium (available from Honjo Metal Co., Ltd.) in anhydrous ethanol (Kanto Chemical Co., Inc.). Then niobium pentaethoxide (Nb(OC₂H₅)₅) (available from KOJUNDO CHEMICAL LABORATORY CO., LTD.) was added to this solution to obtain an alkoxide solution containing lithium and niobium. Using a rolling fluidized bed device, NCM1 powder was made into a fluidized bed, and the alkoxide solution was sprayed, thereby obtaining a precursor powder in which the surface of the NCM powder particles was coated with alkoxide. This precursor powder was then heated at 350 degrees Celsius under a dry air atmosphere, resulting in the synthesis of LNO/NCM, in which the LiNbO₃ layer was formed on the surface of NCM1.

### Preparation of Liquid Composition for Solid Electrolyte Layer

The argyrodite-type sulfide solid electrolyte, Li₆PS₅Cl (LPSC), was synthesized as a sulfide solid electrolyte based on the synthesis method described in J. Power Sources, 2018, 396, 33-40. Specifically, 0.5 g of Li₂S (99.9 percent, available from Mitsuwa Chemical Co., Ltd.), 0.5 g of P₂S₅ (99 percent, available from Sigma-Aldrich Co. LLC.), and 0.5 g of LiCl (99 percent, available from Sigma-Aldrich Co. LLC.) were ground for 40 hours using a planetary ball mill (PULVERISETTE, available from Fritsch Germany) to obtain the sulfide solid electrolyte. The grinding was carried out in a zirconia pot (45 mL) using 15 zirconia balls (diameter: 10 mm) at 600 RPM.

For the preparation of the liquid composition for the solid electrolyte layer, octane (available from Tokyo Chemical Industry Co., Ltd.) was used as the solvent. At this time, 10 g of molecular sieve 4A 1/16 (available from Kanto Chemical Co., Inc.) was added per 100 mL of octane, and dehydration was performed by leaving it to rest for 12 hours. It was confirmed that the water content was at most 100 ppm using a Karl Fischer moisture meter. To this solvent (100 parts by mass), 100 parts by mass of the sulfide solid electrolyte synthesized and 1 part by mass of a dispersant (Solsperse™ 21000, available from Lubrizol Corporation) were added and mixed to obtain a liquid composition for the solid electrolyte layer.

### Preparation of Positive Electrode

LN0/NMC (45.3 percent by mass) as a positive electrode material was dispersed in anisole (36.4 percent by mass, available from Tokyo Chemical Industry Co., Ltd.) along with acetylene black (2.2 percent by mass, available from DENKA Co., Ltd.) as a conductive material, polybutyl methacrylate (PBMA, available from Aldrich Co., Ltd.) as a binder (1.4 percent by mass), and sulfide solid electrolyte (14.7 percent by mass), forming a positive electrode paint.

This positive electrode paint was applied to both sides of an aluminum foil substrate and dried to obtain a 20 mm×20 mm positive electrode. The average thickness was 95 μm, and the battery capacity per unit area was 2.91 mAh/cm².

### Preparation of Negative Electrode

On a stainless steel foil, a lithium metal with an average thickness of 50 μm (available from Honjo Metal Co., Ltd.) was attached. Additionally, a 50 μm thick indium foil (available from The Nilaco Corporation) was laminated on top to obtain a 25 mm×25 mm negative electrode.

### Fabrication of Solid State Battery

Liquid Composition 1 was filled into an inkjet discharging device equipped with GEN5 heads (available from Ricoh Co; Ltd.).

The positive electrode was placed on a stage, and Liquid Composition 1 was applied such that the distance between the outer periphery of the positive electrode and the insulating resin layer had a width of 10 mm. The coated area was then immediately exposed to UV light under a nitrogen atmosphere (light source: UV-LED (available from Phoseon Technology, product name: FJ800), wavelength: 365 nm, irradiation intensity: 30 mW/cm², irradiation time: 20 s) to cure the coating. Next, with a hot plate, the cured material was heated at 120 degrees C. for 1 minute to remove the solvent, forming the positive electrode-insulating resin layer.

At this stage, the average thickness of the insulating resin layer was 124 μm, and the curl of the insulating resin layer was 0 mm.

After the positive electrode-insulating resin layer with aluminum laminate was sealed, it was pressurized at 500 MPa for 5 minutes using a cold isostatic press (CIP). After the pressurization, the positive electrode-insulating resin layer was removed from the aluminum laminate.

The liquid composition for the solid electrolyte layer was applied to the positive electrode by the bar coating method. After coating, it was sealed again with aluminum laminate and pressurized at 500 MPa for 5 minutes using the CIP. The positive electrode-insulating resin layer and the negative electrode were placed facing each other, with lead wires attached to each. The assembly was then vacuum-sealed using a laminate, forming Solid State Battery 1.

Measurements of the battery voltage of the solid-state Battery 1 fabricated showed 2.05 V. The solid state battery was able to be stably charged without short circuits at a constant current up to 3.6 V with a current value corresponding to 20 percent of the theoretical capacity per unit area of the positive electrode active material.

### Example 136

Liquid Composition 5 was filled into an inkjet discharging device equipped with GEN5 heads (available from Ricoh Co; Ltd.). The positive electrode was placed on a stage, and Liquid Composition 5 was discharged and applied such that the distance between the outer periphery of the positive electrode and the resin had a frame of 10 mm. The coated area was then immediately exposed to UV light under a nitrogen atmosphere (light source: UV-LED (available from Phoseon Technology, product name: FJ800), wavelength: 365 nm, irradiation intensity: 30 mW/cm², irradiation time: 20 s) to cure the coating. Next, with a hot plate, the cured material was heated at 120 degrees C. for 1 minute to remove the solvent, forming the positive electrode-insulating resin layer.

At this stage, the average thickness of the insulating resin layer was 113 μm, and the curl of the insulating resin layer was 0 mm.

Solid State Battery 2 was manufactured in the same manner as in Example 135. The voltage of the fabricated solid state battery 2 was measured to be 2.09 V. The solid state battery was able to be stably charged without short circuits at a constant current up to 3.6 V with a current value corresponding to 20 percent of the theoretical capacity per unit area of the positive electrode active material.

### Example 137

Liquid Composition 11 was filled into an inkjet discharging device equipped with GEN5 heads (available from Ricoh Co; Ltd.). The positive electrode was placed on a stage, and Liquid Composition 11 was discharged and applied such that the distance between the outer periphery of the positive electrode and the resin had a frame of 10 mm. The coated area was then immediately exposed to UV light under a nitrogen atmosphere (light source: UV-LED (available from Phoseon Technology, product name: FJ800), wavelength: 365 nm, irradiation intensity: 30 mW/cm², irradiation time: 20 s) to cure the coating. Next, with a hot plate, the cured material was heated at 120 degrees C. for 1 minute to remove the solvent, forming the positive electrode-insulating resin layer.

At this stage, the average thickness of the insulating resin layer was 121 μm, and the curl of the insulating resin layer was 0 mm.

Solid State Battery 3 was manufactured in the same manner as in Example 135. The voltage of the fabricated solid state battery 3 was measured to be 2.09 V. The solid state battery was able to be stably charged without short circuits at a constant current up to 3.6 V with a current value corresponding to 20 percent of the theoretical capacity per unit area of the positive electrode active material.

### Method of Measuring Capacity Per Unit of Area

The capacity per unit area of the electrode was measured using a charge-discharge measurement device TOSCAT 3001 (available from TOYO SYSTEM CO., LTD.) First, the electrode fabricated electrode was punched into a 10 mm diameter circular shape.

The capacity of the positive electrode containing the solid electrolyte was evaluated using the following method: In an argon atmosphere, the positive electrode was punched into a 10 mm diameter circular electrode at capacity per unit area.

After 80 g of sulfide solid electrolyte was placed into a polyethylene terephthalate (PET) tube of a two-electrode cell (available from Housen Corp.), a pressing pin was placed on top, and the assembly was molded at a displayed pressure of 10 MPa for 1 minute using a uniaxial press machine (P-6, available from RIKEN SEIKI). Next, the 10 mm diameter punched positive electrode was placed such that the active material surface was in contact with the sulfide solid electrolyte inside the PET tube, a pressing pin was set, and the assembly was molded at a displayed pressure of 30 MPa for 1 minute using the uniaxial press machine.

A structure consisting of lithium (available from Honjo Metal Co., Ltd.) with an average thickness of 50 μm and indium (available from Niraco Co., Ltd.) with an average thickness of 50 μm laminated on an SUS foil with an average thickness of 10 μm was placed on the opposite side of the positive electrode composite layer. This assembly was then molded at a displayed pressure of 12 MPa for 3 seconds using the uniaxial press machine. The PET tube with the pressing pin on was placed into the two-electrode cell and sealed at a displayed pressure of 25 N·m using a digital torque ratchet (KTC Tool) to fabricate an electrochemical element. This electrochemical element was subjected to initial charge-discharge testing at room temperature (25 degrees Celsius) by charging to 3.6 V with a constant current corresponding to 20 percent of the capacity per unit area calculated from the theoretical capacity of the positive electrode active material, and then discharging to 2.4 V at a constant current. This initial charge-discharge process was repeated two times, and the discharge capacity of the second cycle was measured as the initial capacity per unit area of the positive electrode.

Aspects of the present disclosure include, but are not limited to the following:

### Aspect 1

A liquid composition contains a polymerizable compound represented by the following Chemical Formula 1 or Chemical Formula 2, a non-linkable resin having a structural unit represented by the following Chemical Formula 3, and a solvent.

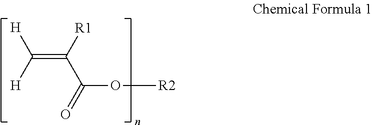

In Chemical Formula 1, R1 represents a hydrogen atom or a methyl group, R2 represents a hydrocarbon chain, an alkylene oxide chain, a polyester chain, or an acrylic oligomer ester derivative, and n represents an integer from 2 to 6.

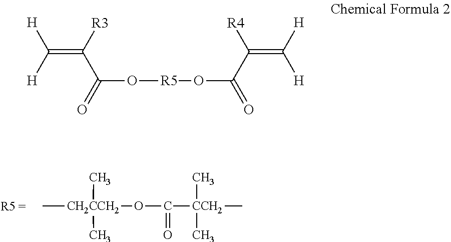

In Chemical Formula 2, R3 and R4 each, independently, represent hydrogen atoms or methyl groups.

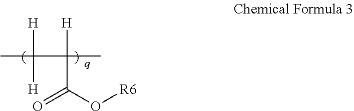

In Chemical Formula 3, R6 represents an alkyl group.

The solvent is a solvent mixture containing a good solvent that dissolves the polymerizable compound and a poor solvent that leaves the polymerizable undissolved, and the solvent satisfies the following Relationship 1.

Polymerizable compound soluble point≤Mixing ratio X<Polymerizable compound soluble point+11 Relationship 1

In Relationship 1, the mixing ratio X represents the content ratio by percentage based on the mass of the good solvent in the solvent mixture, and the polymerizable compound soluble point represents the minimum content ratio by percentage based on the mass of the good solvent in the solvent mixture.

### Aspect 2

A liquid composition contains a polymerizable compound represented by the following Chemical Formula 1 or Chemical Formula 2, a non-linkable resin having a structural unit represented by the following Chemical Formula 3, and a solvent.

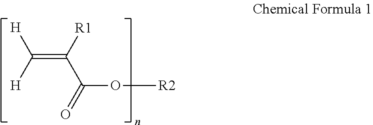

In Chemical Formula 1, R1 represents a hydrogen atom or a methyl group, R2 represents a hydrocarbon chain, an alkylene oxide chain, a polyester chain, or an acrylic oligomer ester derivative, and n represents an integer from 2 to 6.

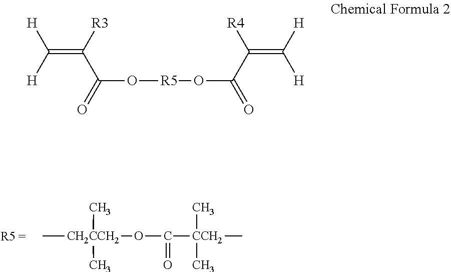

In Chemical Formula 2, R3 and R4 each, independently, represent hydrogen atoms or methyl groups.

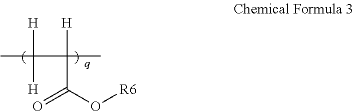

In Chemical Formula 3, R6 represents an alkyl group.

The solvent is a solvent mixture containing a good solvent that dissolves the polymerizable compound and a poor solvent that leaves the polymerizable undissolved, and the solvent satisfies the following Relationship 2.

Solvent soluble point≤Mixing ratio Y<Solvent soluble point+21 Relationship 2

In Relationship 2, the mixing ratio Y represents the content ratio by percentage based on a mass of the insoluble polymerizable compound in the compound mixture, and the solvent soluble point represents the minimum content ratio by percentage based on the mass of the insoluble polymerizable compound in the compound mixture.

### Aspect 3

The liquid compound according to Aspect 1 or Aspect 2 mentioned above, wherein R2 is the polyester chain or the polymerizable compound is represented by Chemical Formula 2.

### Aspect 4

The liquid compound according to any one of Aspects 1 to 3 mentioned above, wherein R2 is the polycaprolactone chain.

### Aspect 5

The liquid composition according to any one of Aspects 1 to 4 mentioned above, wherein R6 is methyl, ethyl, iso-propyl, n-propyl, tert-butyl, iso-butyl, or n-butyl.

### Aspect 6

The liquid composition according to any one of Aspects 1 to 5 mentioned above, wherein the non-linkable resin contains a copolymer containing two or more structural units.

### Aspect 7

The liquid composition according to Aspect 6 mentioned above, wherein the non-linkable resin further comprises a structural unit represented by the following Chemical Formula 4.

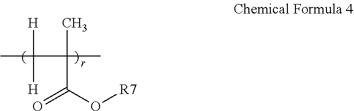

In Chemical Formula 4, R7 represents methyl, ethyl, iso-propyl, n-propyl, tert-butyl, iso-butyl, or n-butyl.

### Aspect 8

The liquid composition according to Aspect 6 or Aspect 7 mentioned above, wherein the copolymer contains a block copolymer.

### Aspect 9

An insulating resin layer contains a cured product of the liquid composition of any one of Aspects 1 to 8 mentioned above, the insulating resin layer having a porous structure.

### Aspect 10

An electrode for an electrochemical element includes a substrate, an electrode composite layer disposed on the substrate, and an insulating resin layer disposed at a peripheral portion of the electrode composite layer, wherein the insulating resin layer is a cured product of the liquid composition of any one of Aspects 1 to 8 mentioned above and has a porous structure.

### Aspect 11

The electrode according to Aspect 10 mentioned above, further contains an adhesive layer disposed between the substrate and the electrode composite layer, the adhesive layer containing a metal that forms an alloy with lithium.

### Aspect 12

The electrode according to Aspect 10 or Aspect 11 mentioned above, wherein the electrode composite layer has an opening.

### Aspect 13

The electrode according to Aspect 12, wherein the opening is filled with a sulfide solid electrolyte.

### Aspect 14

An electrode laminate includes a substrate, an electrode composite layer disposed on the substrate, an insulating resin layer disposed at a peripheral portion of the electrode composite layer, and a solid electrolyte layer disposed on the electrode composite layer and the insulating resin layer, the solid electrolyte layer containing a solid electrolyte, wherein the insulating resin layer is a cured product of the liquid composition of any one of Aspects 1 to 8 mentioned above and has a porous structure.

### Aspect 15

The electrode laminate according to Aspect 14 mentioned above further contains an adhesive layer disposed between the substrate and the electrode composite layer, the adhesive layer containing a metal that forms an alloy with lithium.

### Aspect 16

The electrode laminate according to Aspect 14 or Aspect 15 mentioned above, wherein the electrode composite layer has an opening.

### Aspect 17

The electrode laminate according to Aspect 16 mentioned above, wherein the opening is filled with a sulfide solid electrolyte.

### Aspect 18

An electrochemical element contains the electrode laminate of any one of Aspects 14 to 17 mentioned above.

### Aspect 19

An electric device includes the electrochemical element of Aspect 18 mentioned above.

### Aspect 20

A mobile object includes the solid state electrochemical element of Aspect 18 mentioned above.

### Aspect 21

The mobile object according to Aspect 20 mentioned above being a vehicle.

### Aspect 22

A method of manufacturing an electrode laminate includes forming an electrode composite layer on a substrate, forming an insulating resin layer at a peripheral portion of the electrode composite layer, including applying the liquid composition of any one of Aspects 1 to 8 to the substrate and applying heat or light to the liquid composition to cure the liquid composition, and forming a solid electrolyte layer on the insulating resin layer and the electrode composite layer.

### Aspect 23

The method according to Aspect 22 mentioned above, wherein the applying the liquid composition is carried out by inkjetting.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid composition comprising:
a polymerizable compound represented by the following Chemical Formula 1 or Chemical Formula 2;
a non-linkable resin having a structural unit represented by the following Chemical Formula 3; and
a solvent, 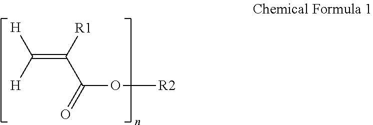
where R1 represents a hydrogen atom or a methyl group, R2 represents a hydrocarbon chain, an alkylene oxide chain, a polyester chain, or an acrylic oligomer ester derivative, and n represents an integer from 2 to 6, 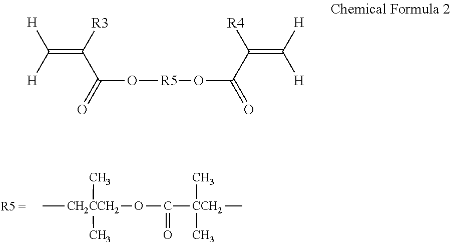
where R3 and R4 each, independently, represent hydrogen atoms or methyl groups, 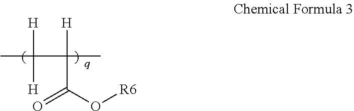
where, R6 represents an alkyl group,
wherein the solvent is a solvent mixture comprising a good solvent that dissolves the polymerizable compound and a poor solvent that leaves the polymerizable undissolved, and
the solvent satisfies the following Relationship 1,
Polymerizable compound soluble point≤Mixing ratio X<Polymerizable compound soluble point+11 Relationship 1
where the mixing ratio X represents a content ratio by percentage based on a mass of the good solvent in the solvent mixture, and the polymerizable compound soluble point represents a minimum content ratio by percentage based on the mass of the good solvent in the solvent mixture.

2. A liquid composition comprising:
a polymerizable compound represented by the following Chemical Formula 1 or Chemical Formula 2;
a non-linkable resin having a structural unit represented by the following Chemical Formula 3; and
a solvent, 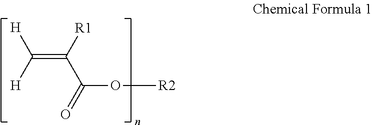
where R1 represents a hydrogen atom or a methyl group, R2 represents a hydrocarbon chain, an alkylene oxide chain, a polyester chain, or an acrylic oligomer ester derivative, and n represents an integer from 2 to 6, 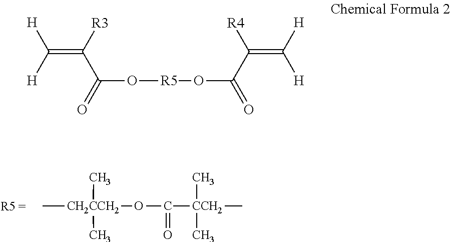
where R3 and R4 each, independently, represent hydrogen atoms or methyl groups, 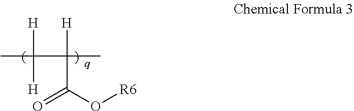
where, R6 represents an alkyl group,
wherein the polymerizable compound comprising a compound mixture comprising a soluble polymerizable compound soluble to the solvent and an insoluble polymerizable compound insoluble to the solvent, and
the polymerizable compound satisfies the following Relationship 2,
Solvent soluble point≤Mixing ratio Y<Solvent soluble point+21 Relationship 2
where the mixing ratio Y represents a content ratio by percentage based on a mass of the insoluble polymerizable compound in the compound mixture, and the solvent soluble point represents a minimum content ratio by percentage based on the mass of the insoluble polymerizable compound in the compound mixture.

3. The liquid composition according to claim 1, wherein R2 is the polyester chain or the polymerizable compound is represented by Chemical Formula 2.

4. The liquid composition according to claim 1, wherein R2 is the polycaprolactone chain.

5. The liquid composition according to claim 1, wherein R6 comprises methyl, ethyl, iso-propyl, n-propyl, tert-butyl, iso-butyl, or n-butyl.

6. The liquid composition according to claim 1, wherein the non-linkable resin comprises a copolymer comprising two or more structural units.

7. The liquid composition according to claim 6, wherein the non-linkable resin further comprises a structural unit represented by the following Chemical Formula 4, 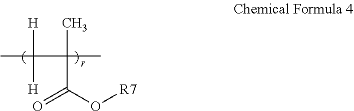
where, R7 represents methyl, ethyl, iso-propyl, n-propyl, tert-butyl, iso-butyl, or n-butyl.

8. The liquid composition according to claim 6, wherein the copolymer comprises a block copolymer.

9. An insulating resin layer comprising:
a cured product of the liquid composition of claim 1, the insulating resin layer having a porous structure.

10. An electrode for an electrochemical element comprising:
a substrate;
an electrode composite layer disposed on the substrate; and
an insulating resin layer disposed at a peripheral portion of the electrode composite layer,
wherein the insulating resin layer is a cured product of the liquid composition of claim 1 and has a porous structure.

11. The electrode according to claim 10, further comprising an adhesive layer disposed between the substrate and the electrode composite layer, the adhesive layer comprising a metal that forms an alloy with lithium.

12. The electrode according to claim 10, wherein the electrode composite layer has an opening.

13. The electrode according to claim 12, wherein the opening is filled with a sulfide solid electrolyte.

14. An electrode laminate comprising:
a substrate;
an electrode composite layer disposed on the substrate;
an insulating resin layer disposed at a peripheral portion of the electrode composite layer; and
a solid electrolyte layer disposed on the electrode composite layer and the insulating resin layer, the solid electrolyte layer comprising a solid electrolyte,
wherein the insulating resin layer is a cured product of the liquid composition of claim 1 and has a porous structure.

15. The electrode laminate according to claim 14, further comprising an adhesive layer disposed between the substrate and the electrode composite layer, the adhesive layer comprising a metal that forms an alloy with lithium.

16. The electrode laminate according to claim 14, wherein the electrode composite layer has an opening.

17. The electrode laminate according to claim 16, wherein the opening is filled with a sulfide solid electrolyte.

18. An electrochemical element comprising:
the electrode laminate of claim 14.

19. A method of manufacturing an electrode laminate comprising:
forming an electrode composite layer on a substrate;
forming an insulating resin layer at a peripheral portion of the electrode composite layer, comprising applying the liquid composition of claim 1 to the substrate and applying heat or light to the liquid composition to cure the liquid composition; and
forming a solid electrolyte layer on the insulating resin layer and the electrode composite layer.

20. The method according to claim 19, wherein the applying the liquid composition is carried out by inkjetting.
